(19) United States
(12) Patent Application Publication
(10) Pub. No.: US 2026/0248342 A1
(43) Pub. Date: Aug. 27, 2026

(54) ROBOT CLEANER STATION

(71) Applicant: LG ELECTRONICS INC., Seoul (KR)

(72) Inventors: Ingyu YANG, Seoul (KR); Daeho CHANG, Seoul (KR); Donggeun LEE, Seoul (KR)

(73) Assignee: LG ELECTRONICS INC., Seoul (KR)

(21) Appl. No.: 19/549,847

(22) Filed: Feb. 25, 2026

(30) Foreign Application Priority Data
Feb. 26, 2025 (KR) 10-2025-0025030

(51) Int. Cl. A47L 11/40; F26B 9/00; F26B 21/00; F26B 21/55

(52) U.S. Cl. CPC A47L 11/4091; A47L 11/4027; F26B 9/003; F26B 21/001; F26B 21/55; A47L 2201/022; A47L 2201/024; A47L 2201/028

(57) ABSTRACT

The present disclosure relates to a robot cleaner station including an inner frame positioned above the base, a exhaust fan disposed above the inner frame and configured to allow wet vapor to flow, and a wet vapor inlet hole into which the wet vapor is introduced, in which the wet vapor inlet hole is positioned below the exhaust fan and discharges wet vapor, which is generated in the robot cleaner station, to reduce the amount of time required to dry a mop of a robot cleaner, prevent damage to an internal configuration of the robot cleaner station, and prevent bacteria proliferation and the occurrence of an offensive odor.

### CROSS-REFERENCE TO RELATED APPLICATION

The present application claims priority to Korean Patent Application No. 10-2025-0025030, filed on 2025.02.26, the entire contents of which are incorporated herein for all purposes by this reference.

### BACKGROUND OF THE DISCLOSURE

### Field of the Disclosure

The present disclosure relates to a robot cleaner station, and more particularly, to a built-in robot cleaner station to which a robot cleaner is coupled, such that when the robot cleaner is coupled to the built-in station, the built-in station may collect dust from a dust bin of the robot cleaner, wash a mop of the robot cleaner, and dry the mop.

### Description of the Related Art

Recently, with the advancement of industrial technologies, robot cleaners, which clean zones required to be cleaned while autonomously traveling without user operations, have been developed.

The robot cleaner may be equipped with a sensor capable of recognizing a space to be cleaned, an agitator capable of cleaning and sweeping a floor surface, and a mop or the like capable of wiping the floor surface. The robot cleaner may travel while sucking dust from the floor surface in the space recognized by the sensor and wiping the floor surface with the mop or the like.

Among the robot cleaners, there are a dry robot cleaner capable of sucking and removing debris scattered on the floor surface, and a wet robot cleaner capable of wiping the floor surface with the mop containing moisture in order to effectively remove debris attached to the floor surface. The dry robot cleaner is equipped with a dust bin and sucks debris on the floor surface by using a suction force of a suction motor. The wet robot cleaner is equipped with a water container and is configured such that water accommodated in the water container is supplied to the mop and the mop containing moisture wipes the floor surface to effectively remove debris attached to the floor surface. In addition, there is also a robot cleaner having a shape equipped with both the agitator and the mop.

A charging stand for the robot cleaner refers to a device in which the robot cleaner, which has completed a cleaning process, is docked. The charging stand is configured to charge a battery provided in the robot cleaner by supplying electric power to the battery. The charging stand is equipped with a power supply module therein. The charging stand is equipped with a charging terminal connected to the power supply module, and the robot cleaner is equipped with a corresponding terminal. In case that the charging terminal and the corresponding terminal come into contact with each other, electric power is supplied to the battery, and the battery is charged.

Meanwhile, in case that the charging stand for the robot cleaner is disposed in a building, the charging stand occupies a predetermined range of an indoor space. In this case, spatial efficiency of the interior may deteriorate. In addition, there may be a risk that the robot cleaner may collide with a user or pet while the user or pet is moving, which causes injury or damage to both the user or pet and the robot cleaner.

In addition, in the case of a station to which a dust collection function of the robot cleaner is added, there is a limitation in that a volume occupied by the station increases, which may degrade the aesthetics of the interior.

Meanwhile, Chinese Utility Model Registration No. CN 218922468 U discloses a cleaner station in which a robot cleaner is coupled to a lower side of a washing machine, the robot cleaner is charged, dust is collected from the robot cleaner, and a wet mop of the robot cleaner is washed.

However, in the cleaner station, an open space into which the robot cleaner is introduced is formed below the washing machine, a device for supplying a detergent and water for cleaning a wet mop is provided vertically above the space into which the robot cleaner is introduced, and a dust bag is disposed at a lateral side of the space into which the robot cleaner is introduced.

Because this arrangement increases an overall height of the cleaner station, there is a limitation in that the cleaner station cannot be mounted by utilizing a lower space of furniture such as a sink.

In addition, because the cleaner station needs to be installed below the washing machine, a space for installing the washing machine needs to be basically and essentially provided. For this reason, there is a limitation in that an installation space having a height higher than a height of the washing machine and a height of the cleaner station needs to be provided.

Chinese Utility Model Registration Nos. CN 217090594 U and CN 217827730 U disclose a drying system of a robot cleaner station that is provided with a hot-air drying module to dry a mop of a robot cleaner.

However, because the drying system of the robot cleaner station does not have a discharge port capable of discharging wet vapor that may be generated during a drying process, dew may be generated inside the robot cleaner station, and condensate water may remain. As a result, moisture remains in the robot cleaner station over a long period of time, which causes a limitation that increases drying time.

In addition, in case that wet vapor remaining in the robot cleaner station is not removed, an environment in which bacteria, such as mold, may proliferate is formed, which causes a problem in that internal devices of the robot cleaner station are damaged, or a severely offensive odor is generated.

### SUMMARY OF THE DISCLOSURE

The present disclosure is proposed to solve these problems of the robot cleaner station in the related art and aims to provide a robot cleaner station capable of being built-in below a kitchen cabinet without requiring a separate installation space.

The present disclosure also aims to provide a robot cleaner station capable of accommodating a robot cleaner in a lower space of a kitchen cabinet having a predetermined height limit.

The present disclosure also aims to provide a robot cleaner station in which a flow path required for dust collection may be disposed at a limited height and in limited left and right spaces, thereby implementing a compact overall size.

The present disclosure also aims to provide a robot cleaner station in which all required flow paths may be disposed in a limited space, and a sufficient flow space may be ensured in each of the flow paths.

The present disclosure also aims to provide a robot cleaner station that may be provided with a discharge part configured to discharge wet vapor generated in the robot cleaner station, thereby shortening the amount of time required to dry a mop of a robot cleaner.

The present disclosure also aims to provide a robot cleaner station that may discharge wet vapor generated in the robot cleaner station, thereby preventing damage to an internal configuration of the robot cleaner station and preventing bacteria proliferation and the occurrence of an offensive odor.

In order to achieve the above-mentioned objects, a robot cleaner station according to the present disclosure may include: a housing; a discharge part configured to discharge wet vapor existing in the housing; a base disposed in the housing and configured such that at least a part of a robot cleaner is seated on the base; and an inner frame positioned above the base.

The discharge part may include a exhaust fan disposed above the inner frame and configured to allow the wet vapor to flow, the inner frame may be formed with a wet vapor inlet hole so that the wet vapor is introduced, and the wet vapor inlet hole may be positioned below the exhaust fan.

The inner frame may include a flow path forming portion positioned rearward of the wet vapor inlet hole and configured to guide the wet vapor discharged from the exhaust fan.

The discharge part may include: a discharge part cover positioned above the exhaust fan and configured to cover the exhaust fan and an upper side of the flow path forming portion; and a discharge pipe extending rearward from the discharge part cover and connected to a rear side of the flow path forming portion.

In this case, a vertical diameter of the discharge pipe may be larger than a vertical diameter of the flow path forming portion.

A lower surface of the discharge pipe may include a connection portion having a point at which an angle at which the connection portion is inclined downward is changed.

That is, a lower surface of the discharge pipe may include: a first lower surface connected to a front end of the connection portion; and a second lower surface connected to a rear end of the connection portion, and a vertical diameter from the first lower surface to a discharge part cover may be smaller than a vertical diameter from the second lower surface to the discharge part cover.

In addition, a bottom surface of the flow path forming portion may be formed to be inclined downward and rearward.

The discharge part may include: a wet vapor outlet port positioned rearward of the exhaust fan and configured to allow the wet vapor to be discharged; and a first flow path formed between the discharge part cover and the flow path forming portion and configured to allow the wet vapor discharged from the wet vapor outlet port to flow.

In this case, a longitudinal axis of the first flow path may intersect an imaginary line having a shortest distance from a front end to a rear end of the housing.

The robot cleaner station may further include: an upper rear cover positioned rearward of the discharge part and configured to cover an upper side of a station internal configuration, in which the upper rear cover includes a partition wall connected to left and right outer walls of the housing and provided with a discharge part insertion groove into which a rear end of the discharge part is inserted.

The upper rear cover may include: a bent portion positioned below the partition wall and formed by being bent downward from the rear end of the discharge part; a cover bottom surface extending rearward from a lower end of the bent portion and formed to be inclined upward and rearward; and a rear rib protruding upward from a rear end of the bottom surface.

The housing may include an upper cover positioned above the discharge part cover, and a rear end of the upper cover may be bent downward and coupled to the rear rib.

The cover bottom surface may include a drain hole through which condensate water is discharged, and the cover bottom surface may be formed to be inclined downward in a direction in which the drain hole is positioned.

The discharge part may be disposed in a direction in which a rotation axis of the exhaust fan intersects a ground surface.

The discharge part insertion groove may be provided with a filter configured to restrict introduction of foreign substances.

The discharge part may further include: a housing damper provided to be in contact with a part of an outer peripheral surface of the exhaust fan housing.

The robot cleaner station may further include: a mop washing part positioned at a left or right side of the base and configured to supply washing water and wash a mop, in which the exhaust fan operates when the washing water is supplied.

The robot cleaner station may further include: a mop drying part positioned rearward of the base, provided with a heater, and configured to dry a mop, in which the exhaust fan operates when the heater operates.

According to the robot cleaner station according to the present disclosure described above, the module, which may charge the robot cleaner, collect dust, and wash the mop, may be disposed in the direction parallel to the robot cleaner, such that the lower space of the kitchen cabinet may be utilized.

In addition, the charging terminal, the dust collection part, the mop washing part, and the mop drying part are disposed to be surrounded based on the robot cleaner, such that various functions of the robot cleaner may be performed.

In addition, the surfaces, which exclude the front surface, may be covered by the kitchen cabinet, thereby providing the user with an aesthetic interior appearance.

In addition, the robot cleaner station may be provided with the discharge part configured to discharge wet vapor generated in the robot cleaner station, thereby shortening the amount of time required to dry the mop of the robot cleaner.

In addition, the robot cleaner station may discharge wet vapor generated in the robot cleaner station, thereby preventing damage to the internal configuration of the robot cleaner station and preventing bacteria proliferation and the occurrence of an offensive odor.

### BRIEF DESCRIPTION OF THE DRAWINGS

FIG. 1 is a view for explaining a state in which a cleaner system according to an embodiment of the present disclosure is installed below a kitchen cabinet.

FIG. 2 is a view for explaining a relationship in which a pipe of the cleaner system according to the embodiment of the present disclosure is connected to a water drain pipe.

FIG. 3 is a perspective view illustrating a robot cleaner station according to the embodiment of the present disclosure.

FIG. 4 is a perspective view illustrating the robot cleaner station with an opened door according to the embodiment of the present disclosure.

FIG. 5 is a perspective view illustrating a robot cleaner coupled to the robot cleaner station according to the embodiment of the present disclosure.

FIG. 6 is a side view of FIG. 3.

FIG. 7 is a bottom plan view of FIG. 3.

FIG. 8 is a rear view of FIG. 3.

FIGS. 9 to 13 are views for explaining an internal structure of the robot cleaner station according to the embodiment of the present disclosure.

FIG. 14 is a view for explaining a flow path forming portion of the robot cleaner station according to the embodiment of the present disclosure.

FIG. 15 is an exploded perspective view illustrating the robot cleaner station according to the embodiment of the present disclosure.

FIG. 16 is a view for explaining an inner frame of the robot cleaner station according to the embodiment of the present disclosure.

FIG. 17 is a view for explaining a discharge part of the robot cleaner station according to the embodiment of the present disclosure.

FIG. 18 is a cross-sectional view taken along line A-A' in FIG. 13.

FIG. 19 is an enlarged view illustrating the rear side of FIG. 15.

FIG. 20 is a block diagram for explaining a control configuration of the robot cleaner station according to the embodiment of the present disclosure.

### DETAILED DESCRIPTION OF THE DISCLOSURE

Hereinafter, exemplary embodiments of the present disclosure will be described in detail with reference to the accompanying drawings.

The present disclosure may be variously modified and may have various embodiments, and particular embodiments illustrated in the drawings will be specifically described below. The description of the embodiments is not intended to limit the present disclosure to the particular embodiments, but it should be interpreted that the present disclosure is to cover all modifications, equivalents and alternatives falling within the spirit and technical scope of the present disclosure.

In the description of the present disclosure, the terms such as "first" and "second" may be used to describe various constituent elements, but the constituent elements may not be limited by the terms. These terms are used only to distinguish one constituent element from another constituent element. For example, a first component may be named a second component, and similarly, the second component may also be named the first component, without departing from the scope of the present disclosure.

The term "and/or" may include any and all combinations of a plurality of the related and listed items.

When one constituent element is described as being "coupled" or "connected" to another constituent element, it should be understood that one constituent element can be coupled or connected directly to another constituent element, and an intervening constituent element can also be present between the constituent elements. When one constituent element is described as being "coupled directly to" or "connected directly to" another constituent element, it should be understood that no intervening constituent element is present between the constituent elements.

The terminology used herein is used for the purpose of describing particular embodiments only and is not intended to limit the present disclosure. Singular expressions may include plural expressions unless clearly described as different meanings in the context.

The terms "comprises," "comprising," "includes," "including," "containing," "has," "having" or other variations thereof are inclusive and therefore specify the presence of stated features, integers, steps, operations, elements, components, and/or combinations thereof, but do not preclude the presence or addition of one or more other features, integers, steps, operations, elements, components, and/or combinations thereof.

Unless otherwise defined, all terms used herein, including technical or scientific terms, may have the same meaning as commonly understood by those skilled in the art to which the present disclosure pertains. The terms such as those defined in a commonly used dictionary may be interpreted as having meanings consistent with meanings in the context of related technologies and may not be interpreted as ideal or excessively formal meanings unless explicitly defined in the present application.

Further, the following embodiments are provided to more completely explain the present disclosure to those skilled in the art, and shapes and sizes of elements illustrated in the drawings may be exaggerated for a more apparent description.

### Kitchen Cabinet and Cleaner System

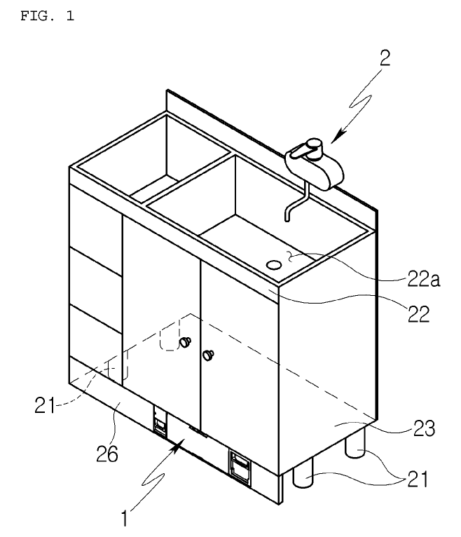

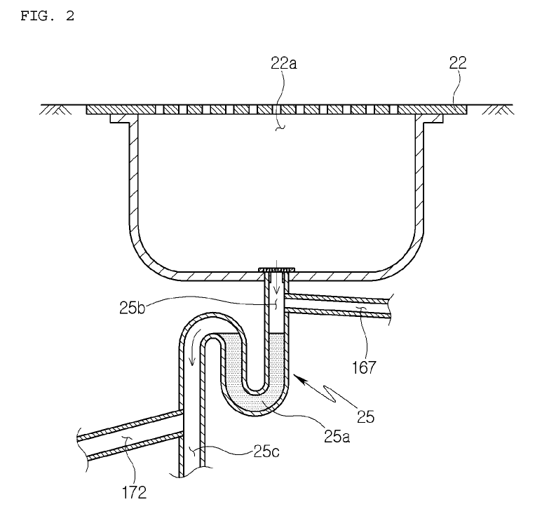

FIG. 1 is a view for explaining a state in which a cleaner system according to an embodiment of the present disclosure is installed below a kitchen cabinet, and FIG. 2 is a view for explaining a relationship in which a pipe of the cleaner system according to the embodiment of the present disclosure is connected to a water drain pipe.

With reference to FIGS. 1 and 2, a cleaner system 1 according to an embodiment of the present disclosure may be provided below a kitchen cabinet 2. Specifically, the kitchen cabinet 2 may be disposed in a kitchen and provide a space in which dishes, plates, cups, and the like may be accommodated and food preparation or dishwashing may be performed.

In addition, the kitchen cabinet 2 may be equipped with an upper plate (worktop) capable of serving as a sink, a cooking stage, or a working stage.

For example, the kitchen cabinet 2 may include a sink configured to provide a space in the upper plate so that dishwashing may be performed. Alternatively, the kitchen cabinet 2 may include a cooking stage on which food preparation is performed. In addition, the kitchen cabinet 2 may include a gas range stage on the upper plate on which a gas range, an induction cooktop, a halogen hob, an oven, or the like is installed.

In general, a standard cabinet having a width of 600 mm in a forward/rearward direction and a width of 600 mm in a leftward/rightward direction may be used as the kitchen cabinet 2.

The cleaner system 1 according to another embodiment of the present disclosure may be provided below a structure including at least any one of a water supply pipe and a water drain pipe. Specifically, the water supply pipe may refer to a flow path connected to an external water supply source configured to supply a fluid to the structure, and the water drain pipe may refer to a flow path configured to discharge a fluid, which is discharged from the structure, to a sewage system.

A storage cabinet configured to store dishes, kitchen tools, and the like may be provided below the kitchen cabinet 2 or the structure. That is, the kitchen cabinet 2 or the structure may include an upper plate 22 configured to provide a space in which tasks such as cooking or dishwashing may be performed, a lower plate 23 disposed to be spaced apart from a ground surface by a predetermined height, and an accommodation space formed between the upper plate 22 and the lower plate 23 and configured to accommodate dishes, kitchen tools, and the like. In this case, in case that the kitchen cabinet 2 is a sink, a basin 22a may be disposed in the upper plate 22.

In addition, the lower plate 23 may be supported by pedestals 21. The pedestals 21 may be disposed in a direction perpendicular to a floor of the kitchen and support a load of the kitchen cabinet 2. In this case, a space may be formed between the floor of the kitchen and the lower plate 23 in accordance with heights of the pedestals 21.

On the contrary, the kitchen cabinet 2 may be fixed to a wall of a building without the pedestal 21. Even in this case, a space may be formed between the floor of the kitchen and the lower plate 23.

The cleaner system 1 according to the embodiment of the present disclosure is mounted in a space (hereinafter, referred to as a 'mounting space') between the floor of the kitchen and the lower plate 23, as described above.

For example, the mounting space may have a height of 200 mm or less, and generally, a height of 160 mm or less.

Therefore, according to the present disclosure, the cleaner system 1 is disposed in a lower space of the kitchen cabinet 2, which minimizes a degree to which the cleaner system 1 is exposed to the outside.

In addition, the cleaner system 1 does not occupy a separate space in comparison with a case in which a charging stand for a robot cleaner is disposed in a predetermined space of a living room, a room, or a kitchen. The cleaner system 1 is disposed in an unused space formed by the kitchen cabinet 2, thereby maximizing spatial efficiency.

### Cleaner System

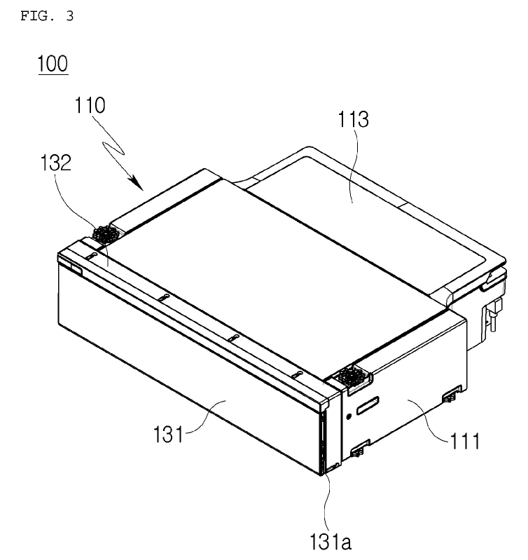

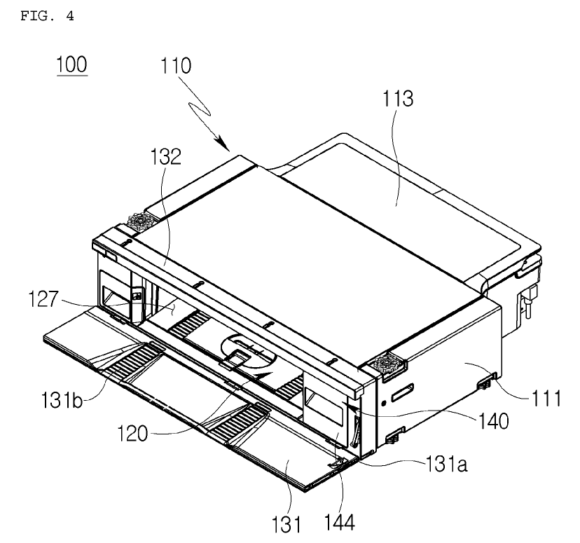

FIGS. 3 to 4 are views for explaining the robot cleaner in the robot cleaner station according to the embodiment of the present disclosure.

With reference to FIGS. 3 to 4, the cleaner system 1 according to the embodiment of the present specification may include a robot cleaner station 100 and a robot cleaner 200.

The cleaner system 1 includes the robot cleaner station 100. The robot cleaner 200 may be coupled to the robot cleaner station 100. Specifically, the robot cleaner 200 may enter a front side of the robot cleaner station 100, and the robot cleaner 200 may be accommodated in the robot cleaner station 100. The robot cleaner station 100 may remove dust from a dust bin 220 of the robot cleaner 200. The robot cleaner station 100 may wash a rotary cleaning part 240 of the robot cleaner 200. The robot cleaner station 100 may dry the rotary cleaning part 240 of the robot cleaner 200. The robot cleaner station 100 may supply electric power to the robot cleaner 200.

### Robot Cleaner

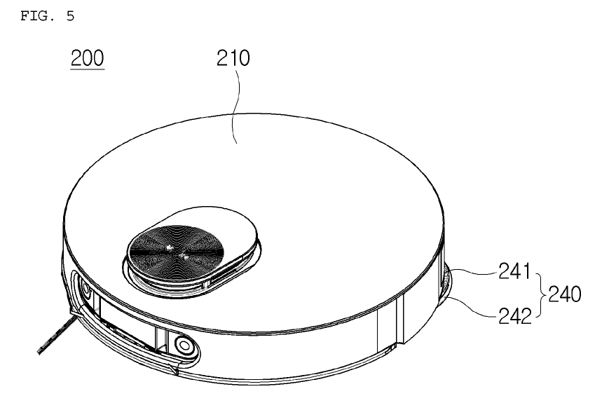

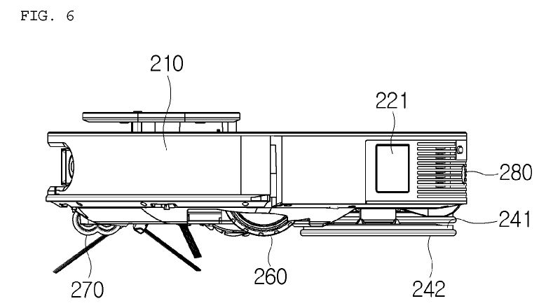

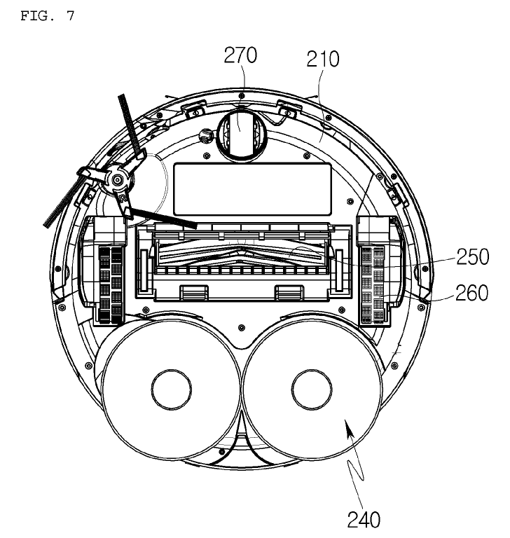

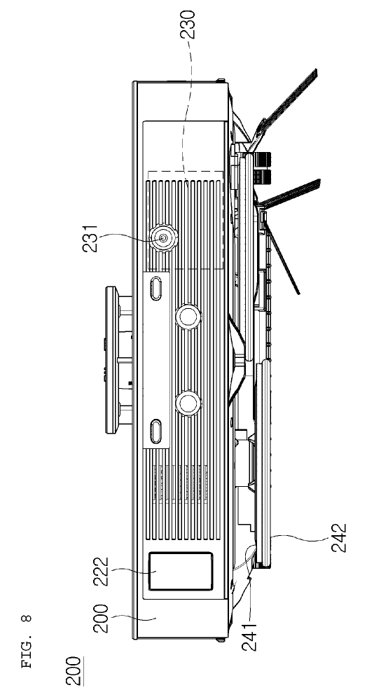

Meanwhile, FIGS. 5 to 8 are views for explaining the robot cleaner in the robot cleaner system according to the embodiment of the present disclosure.

A structure of a robot cleaner 200 will be described below with reference to FIGS. 5 to 8.

The robot cleaner 200 may automatically clean a zone to be cleaned by sucking foreign substances such as dust from a floor while autonomously traveling in the zone to be cleaned.

The robot cleaner 200 according to the embodiment of the present disclosure is configured to be placed on a floor and clean the floor while moving on a floor surface. Therefore, hereinafter, an upward/downward direction is defined based on a state in which the robot cleaner 200 is placed on the floor.

Further, based on a pair of wheels 260, a side at which an auxiliary wheel 270 to be described below is defined as a front side, and a side at which the rotary cleaning part 240 to be described below is disposed is defined as a rear side.

Among the portions described in the embodiment of the present disclosure, a 'lowermost portion' may be a portion positioned at a lowest position or a portion closest to the floor when the robot cleaner 200 according to the embodiment of the present disclosure is placed on the floor and used.

The robot cleaner 200 according to the embodiment of the present disclosure includes a body 210, the dust bin 220, a water container 230, the rotary cleaning part 240, an agitator 250, the wheels 260, the auxiliary wheel 270, and a charging terminal 280.

The body 210 may define an overall external shape of the robot cleaner 200. Components constituting the robot cleaner 200 may be coupled to the body 210, and some of the components constituting the robot cleaner 200 may be accommodated in the body 210.

Specifically, the components of the robot cleaner 200 may be provided in a space in the body 210. For example, a battery and at least one motor may be accommodated in the space in the body 210.

In the embodiment of the present disclosure, the body 210 has a shape in which a width (or diameter) in a horizontal direction is larger than a height in an upward/downward direction. The body 210 may provide an advantageous structure that assists the robot cleaner 200 in having a stable structure and allows the robot cleaner 200 to avoid an obstacle while moving traveling.

The body 210 may have various shapes such as a circular shape, an elliptical shape, or a quadrangular shape when viewed from above or below.

The body 210 may be divided into a lower body and an upper body, and the lower body and the upper body may be coupled to define the space in the body 210.

The lower body may be coupled to the upper body to define the space capable of accommodating therein the battery, at least one sensor, and at least one motor.

A suction part 211 into which air is introduced may be formed in the lower body, and a hole configured to accommodate the pair of wheels 260 may be formed in the lower body.

The suction part 211 may be a passageway into which dust on the floor surface is introduced. Further, the suction part 211 may communicate with a suction flow path (not illustrated) formed in the body 210, and the suction flow path may communicate with an internal space of the dust bin 220.

Meanwhile, the lower body may be further provided with an air discharge flow path. One side of the air discharge flow path may communicate with the internal space of the dust bin 220, and the other side of the air discharge flow path may communicate with an air discharge outlet. In this case, a filter may be disposed in the air discharge outlet.

With this configuration, the air introduced through the suction part 211 may flow into the dust bin 220 through the suction flow path and be discharged to the air discharge outlet through the air discharge flow path.

The agitator 250 to be described below may be rotatably accommodated in the suction part 211. With this configuration, dust present around the suction part 211 may be guided into the suction part 211 by a rotation of the agitator 250, thereby improving efficiency in sucking dust.

The upper body may define an external appearance of an upper side of the robot cleaner 200. Although not illustrated, a display may be provided on the upper body.

The robot cleaner 200 of the present disclosure may include a bumper. The bumper is coupled along a rim of the body 210 and configured to move relative to the body 210.

The bumper may be coupled along a part of the rim of the body 210 or coupled along the entire rim of the body 210. At least one elastic member (not illustrated) may be provided between the bumper and the body 210. With this configuration, when the bumper comes into contact with an obstacle or the like and relatively moves toward a center of the body 210, the bumper may be returned to an original position by a restoring force of the elastic member (not illustrated), and the elastic member (not illustrated) may absorb or disperse impact applied to the bumper to prevent and reduce the transmission of the impact to the body 210.

The dust bin 220 may be provided to suck outside dust and air and store dust.

The dust bin 220 may store dust that passes through the suction flow path and is introduced. The dust bin 220 may have a dust inlet port configured to communicate with the suction flow path, the internal space capable of storing dust, and an air discharge port through which air may be discharged.

The dust bin 220 may be provided in the body 210. In this case, the dust bin 220 may be fixedly coupled to the body 210. Of course, according to the embodiment, the dust bin 220 may be separably provided.

Meanwhile, in the present disclosure, a dust discharge flow path may be formed in the dust bin 220. The dust discharge flow path may allow the internal space of the dust bin 220 and an external space of the robot cleaner 200 to communicate with each other. With this configuration, in case that the robot cleaner station 100 collects dust, the dust in the dust bin 220 may be removed.

Meanwhile, a dust discharge port 221, which communicates with the dust discharge flow path, may be formed in the dust bin 220 according to the embodiment of the present disclosure. For example, the dust discharge port 221 may be formed at one side of a rear side of an outer surface (or outer peripheral surface) of the body 210. In another example, the dust discharge port 221 may be formed in an outer surface of the dust bin 220.

In addition, the robot cleaner 200 according to the embodiment of the present disclosure may have a dust bin door 222 configured to selectively open or close the dust discharge port 221. Specifically, the dust bin door 222 may be coupled to the body 210 and disposed at a position at which the dust bin door 222 may block the dust discharge port 221. For example, the dust bin door 222 may be made of rubber or resin and configured to be flipped, and one side of the dust bin door 222 may be fixedly coupled to the body 210.

With this configuration, when a dust collection motor 145 of the robot cleaner station 100 to be described below operates, the dust bin door 222 is elastically deformed by driving power of the dust collection motor 145, and the dust discharge port 221 is opened, such that the dust in the dust bin 220 may be collected by a dust collection part 140 of the robot cleaner station 100.

The water container 230 may be provided in the form of a container having an internal space to store therein a liquid such as water. The water container 230 may be disposed in the body 210 and fixedly coupled to the body 210 or detachably coupled to the body 210.

The water container 230 include a supply part 231 and a nozzle (not illustrated). The supply part 231 may be configured to supply a liquid such as water from the outside. For example, the supply part 231 may have an injection port formed at the other side of the rear side of the outer surface (or outer peripheral surface) of the body 210, and the supply part 231 may be connected to a storage space in the water container 230 through a water supply hose.

In this case, with a relationship with the dust discharge port 221, the supply part 231 may be disposed at a side opposite to the robot cleaner 200 in the leftward/rightward direction. For example, in case that the dust discharge port 221 is disposed at a rear left side of the body 210, the supply part 231 may be disposed at a rear right side of the body 210.

With the above-mentioned configuration, in the state in which the robot cleaner 200 is coupled to a robot cleaner station 100, the robot cleaner station 100 may perform both the dust collection and the water injection.

Meanwhile, the nozzle (not illustrated) is provided in the form of a tube or pipe and connected to the water container 230 so that the liquid in the water container 230 may flow through the interior of the nozzle. The nozzle (not illustrated) may be disposed such that one side thereof is connected to the water container 230, and the other end thereof is positioned above a pair of rotary plates 241 or positioned on each of the pair of rotary plates 241. Therefore, the liquid in the water container 230 may be supplied to the pair of mops 242.

That is, the nozzle (not illustrated) may be provided in a shape in which two tube portions are diverged from a single tube portion. In this case, an end of one diverged tube portion may be positioned above a left mop, and an end of the other diverged tube portion may be positioned above a right mop.

Meanwhile, although not illustrated, the water container 230 is equipped with a pump, and the pump may allow the water in the water container 230 to flow to the nozzle (not illustrated). Therefore, when the pump of the water container 230 operates, the liquid stored in the water container 230 may be discharged to the rotary cleaning part 240 through the nozzle (not illustrated).

The rotary cleaning part 240 includes the rotary plates 241 and the mops 242.

The rotary plates 241 may be provided as the pair of rotary plates 241 including a left rotary plate and a right rotary plate, and the mops 242 may be provided as the pair of mops 242 including the left mop and the right mop.

The rotary plate 241 may be rotatably disposed on a bottom surface of the body 210, and the mop 242 may be coupled to a lower side of the rotary plate 241.

The rotary plate 241 has a predetermined area and is provided in the form of a flat plate, a flat frame, or the like. The rotary plate 241 is laid approximately horizontally. Therefore, the rotary plate 241 has a shape in which a width (or diameter) thereof in the horizontal direction is sufficiently larger than a height thereof in the upward/downward direction. The rotary plate 241 coupled to the body 210 may be parallel to the floor surface or inclined with respect to the floor surface. The rotary plate 241 may have a circular plate-like shape, the bottom surface of the rotary plate 241 may have an approximately circular shape, and the rotary plate 241 may have a rotationally symmetrical shape as a whole.

The pair of rotary plates 241 may be vertically symmetric.

The mop 242 may be coupled to the lower side of the rotary plate 241 so as to face the bottom surface.

The mop 242 is configured such that a bottom surface of the mop 242 facing the floor has a predetermined area. The mop 242 has a flat shape. The mop 242 is configured such that a width (or diameter) thereof in the horizontal direction is sufficiently larger than a height thereof in the upward/downward direction. When the mop 242 is coupled to the body 210, the bottom surface of the mop 242 may be parallel to the floor or inclined with respect to the floor.

The bottom surface of the mop 242 may have an approximately circular shape, and the mop 242 may have a rotationally symmetrical shape as a whole. In addition, the mop 242 may be attached to or detached from the bottom surface of the rotary plate 241. The mop 242 may be coupled to the rotary plate 241 and rotate together with the rotary plate 241.

Meanwhile, although not illustrated, the rotary cleaning part 240 may be equipped with a drive part configured to apply a rotational force to the rotary plate 241. For example, the drive part may be provided with a motor and at least one gear. Therefore, when the drive part operates, the rotary plates 241 and the mops 242 may rotate to wipe and clean the floor surface.

The agitator 250 may have a plurality of brushes configured to be rotatable and guide outside dust and air into the dust bin 220. In this case, the agitator 250 may be provided with at least one gear.

Meanwhile, the agitator 250 according to the present embodiment may be equipped with a separate agitator motor (not illustrated) to receive rotational power. According to the embodiment, the agitator 250 may also receive rotational power from a driving motor or receive rotational power from the drive part of the rotary cleaning part 240.

The wheels 260 may be provided on the bottom surface of the body 210 and connected to the drive part (not illustrated). In this case, the drive part (not illustrated) may be coupled to the body 210.

The wheels 260 may be provided on the body 210 and roll on the floor.

The wheels 260 may include a first driving wheel and a second driving wheel. In this case, the first driving wheel may be identical to the second driving wheel, or the first driving wheel and the second driving wheel may be symmetric. For example, in case that the first driving wheel is positioned at the left side of the robot cleaner 200, the second driving wheel may be positioned at the right side of the robot cleaner 200. In this case, the first driving wheel and the second driving wheel may be symmetric vertically.

The drive part (not illustrated) may include driving motors and gears. In this case, the driving motors may be accommodated in the body 210 and provide power to the wheels 260. The driving motors may include a first driving motor and a second driving motor.

The driving motor may be configured as an electric motor. The plurality of gears engage with one another and rotate. The plurality of gears connect the driving motors and the wheels 260 and transmit rotational power of the driving motors to the wheels 260. Therefore, the wheels 260 may rotate when rotary shafts of the driving motors rotate.

With this configuration, when the driving motors operate, the wheels 260 may rotate, and the body 210 may travel on the floor surface at a predetermined traveling speed.

The auxiliary wheel 270 may be provided on a lower surface of the body 210 and roll on the floor surface (cleaning target surface). The auxiliary wheel 270, together with the pair of wheels 260, may support the body 210 on the floor surface. With this configuration, the auxiliary wheel 270 may guide a motion of the robot cleaner 200 while minimizing friction between the robot cleaner 200 and the floor surface.

The suction motor (not illustrated) may generate a suction force capable of sucking outside dust and air through the suction part 211. For example, the suction motor (not illustrated) may be an electric motor. By the suction force generated by the suction motor (not illustrated), outside dust and air may be introduced into the suction part 211 and reach the dust bin 220 after passing through the suction flow path.

Although not illustrated, the battery is coupled to the body 210 and configured to supply electric power to other components constituting the robot cleaner 200. The battery may supply electric power to at least one motor provided in the robot cleaner 200. For example, the battery may supply electric power to the motors provided in the rotary cleaning part 240, the agitator 250, the wheel 260, and the suction motor (not illustrated).

In addition, the battery may supply electric power to a sensor part (not illustrated) and a controller (not illustrated).

The battery may be charged with external electric power. To this end, the charging terminal 280 for charging the battery may be provided at one side of the body 210. For example, the charging terminal 280 may be disposed at a rear side of the outer surface of the body 210. The charging terminal 280 may be supplied with electric power by coming into contact with an electric power supply terminal 123b of the robot cleaner station 100 when the robot cleaner 200 is coupled to the robot cleaner station 100.

### Seating Part

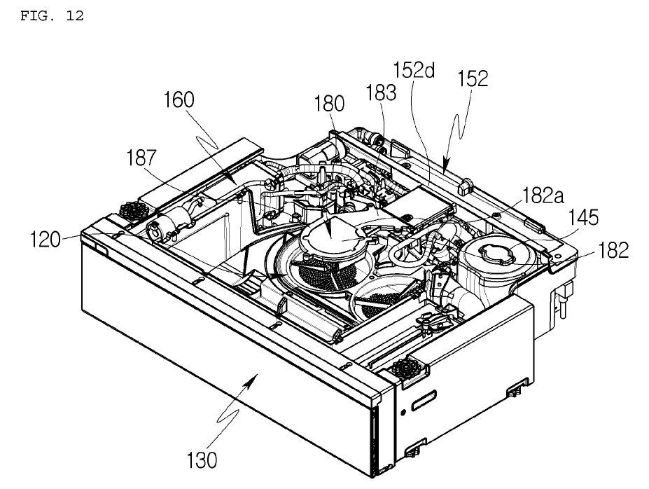

As illustrated in FIG. 12, the robot cleaner station 100 may include the seating part 120.

The robot cleaner 200 and the robot cleaner station 100 may be connected through the seating part 120 in a physical, electrical, and/or flow path manner.

The seating part 120 may be disposed in the housing 110.

In this case, according to the embodiment, the seating part 120 may be configured to be extracted from the housing 110 by means of the drawer 190.

With this configuration, in case that the seating part 120 is required to be washed or repaired or in case that some components are required to be replaced, the user may easily extract and manage the seating part 120.

The seating part 120 may have an inlet/outlet 127 into which the robot cleaner 200 is introduced. The inlet/outlet 127 may refer to a space formed in the front surface of the robot cleaner station 100.

The inlet/outlet 127 may be sized to allow the robot cleaner 200 to pass therethrough. That is, a height of the inlet/outlet 127 is larger than a height of the robot cleaner 200. In this case, the inlet/outlet 127 may refer to a space formed upward in the vertical direction from a front end of a base 121 to be described below. An upper end of the inlet/outlet may be identical to a lower surface of the lower plate 23 of the kitchen cabinet 2 or the upper end of the housing 110.

In addition, a width of the inlet/outlet 127 in the leftward/rightward direction is larger than a maximum width of the robot cleaner 200. In this case, at least one of the dust collection part 140 and the mop washing part 160 may be disposed at the left and right sides of the inlet/outlet 127. Therefore, the left and right ends of the inlet/outlet 127 may define a boundary with the dust collection part 140 and the mop washing part 160. If any one of the dust collection part 140 or the mop washing part 160 is not provided, an outer wall surface of the housing 110 may define a boundary.

In this case, the inlet/outlet 127 may be opened or closed by the door 131. The door 131 may be disposed at an upper or lower end of the inlet/outlet 127 and have a rotary shaft provided in a direction parallel to the base 121. The door 131 may be hingedly coupled to the housing 110. Alternatively, the door 131 may be hingedly coupled to the inner wall 124 of the seating part 120.

The door 131 may be rotated by the door driving part 126a. For example, the door driving part 126a may be a motor.

For example, the door 131 may be formed in a rectangular flat plate-like shape. A hinge part 126b may be provided at an upper end of the door 131, and the door driving part 126a may be connected to an one axial end of the hinge part 126b. In this case, the hinge part 126b of the door 131 may be connected directly to the shaft of the door driving part 126a or connected to the shaft of the door driving part 126a by means of at least one gear so as to transmit power.

The state in which the door 131 closes the inlet/outlet 127 may be maintained in the state in which the robot cleaner 200 is accommodated in the seating part 120. Further, the door 131 may rotate to open the inlet/outlet 127 in case that the robot cleaner 200 begins to travel from the seating part 120. Further, the door 131 may rotate to close the inlet/outlet 127 after the robot cleaner 200 passes through the inlet/outlet 127. In addition, when the robot cleaner 200 approaches the cleaner station 100 from the outside, the door 131 may rotate to open the inlet/outlet 127.

The seating part 120 may include an accommodation space S, a base 121, a coupling wall 123, and inner walls 124.

The robot cleaner 200 may be accommodated in the accommodation space S of the seating part 120. For example, the accommodation space S may refer to a space surrounded by the base 121, the coupling wall 123, and the inner walls 124. In another example, the accommodation space S may refer to a space surrounded by the base 121, a washing plate 122, the coupling wall 123, and the inner walls 124. In still another example, the accommodation space S may refer to a space in which the robot cleaner 200 is positioned in a state in which the robot cleaner 200 is coupled to the electric power supply terminal 123b or a space in which the robot cleaner 200 is positioned in a state in which the dust bin 220 of the robot cleaner 200 communicates with a dust passage hole 123a.

The base 121 may be disposed such that the robot cleaner station 100 adjoins the floor surface. The base 121 may be configured to support the robot cleaner 200 in case that the robot cleaner 200 is coupled to the robot cleaner station 100. The wheel 260 of the robot cleaner 200 may come into contact with an upper surface of the base 121. In addition, the auxiliary wheel 270 of the robot cleaner 200 may come into contact with the upper surface of the base 121.

The base 121 may include a base main body 121a, an inclined portion 121b, wheel coupling portions 121c, an agitator accommodation portion 121d, and a washing tub 128.

The base main body 121a may define an overall external shape of the base 121. The inclined portion 121b, the wheel coupling portions 121c, the agitator accommodation portion 121d, and the washing tub 128 may be disposed on the base main body 121a.

The base main body 121a may have a shape in which a width (or diameter) thereof in the horizontal direction (the direction parallel to the X-axis and the Y-axis) is larger than a height in the vertical direction (the direction parallel to Z-axis). With this structure, the robot cleaner station 100 may be stably supported on the floor surface.

A return flow path may be provided in the base main body 121a. Therefore, air discharged from the dust collection motor 145 may flow through the return flow path formed in the base main body 121a and be discharged to the air return port 125b.

The inclined portion 121b may be disposed in an inlet of the base main body 121a on which the robot cleaner 200 climbs.

The inclined portion 121b may be inclined upward and forward in the direction in which the robot cleaner 200 enters. More specifically, the front end of the inlet side of the inclined portion 121b may be connected to the ground surface without a height difference and inclined upward and forward in the direction in which the robot cleaner 200 enters. In this case, the front side based on the direction in which the robot cleaner 200 enters may refer to the rear side based on the robot cleaner station 100. Therefore, the robot cleaner 200 may easily climb from the ground surface to the robot cleaner station 100.

The inclined portion 121b may have wheel guide portions 121ba.

The wheel guide portion 121ba may be provided in the form of a groove to guide the movement of the robot cleaner 200 relative to the wheel 260. A surface of the wheel guide portion 121ba may be formed to correspond to a surface of the wheel 260 so that the robot cleaner 200 may stably travel. In addition, an inlet of the wheel guide portion 121ba on which the robot cleaner 200 climbs may be formed so that widths of grooves are larger than a width of the wheel 260, and the widths of the grooves may decrease in comparison with the inlet toward a front side of a climbing route of the robot cleaner 200. Therefore, the wheel 260 of the robot cleaner 200 may easily enter the robot cleaner station 100, and the leftward and rightward movements of the wheel 260 are restricted by the grooves having the widths that gradually decrease, such that the wheel 260 may be guided to an exact position.

The inclined portion 121b may have an auxiliary wheel guide portion 121bb.

The auxiliary wheel guide portion 121bb may be provided in the form of a groove in order to guide the movement of the robot cleaner 200 relative to the auxiliary wheel 270. In addition, the auxiliary wheel guide portion 121bb may be formed in a protruding shape so that the auxiliary wheel guide portion 121bb adjoins the auxiliary wheel 270 when the wheel 260 of the robot cleaner 200 is seated on the wheel guide portion 121ba. Therefore, when the robot cleaner 200 travels on the inclined portion 121b, the robot cleaner 200 may travel while being stably supported by the auxiliary wheel 270 as well as the wheels 260.

The wheels 260 of the robot cleaner 200 raised along the wheel guide portions 121ba may be seated on the wheel coupling portions 121c. When the wheel 260 of the robot cleaner 200 is seated on the wheel coupling portion 121c, the robot cleaner 200 and the robot cleaner station 100 may be physically coupled. The surface of the wheel coupling portion 121c may be formed to correspond to the surface of the wheel 260 so that the robot cleaner 200 may be stably stopped. The wheel coupling portion 121c may extend from an upper end of the wheel guide portion 121ba. The wheel coupling portion 121c may be connected to the wheel guide portion 121ba without a level difference. Therefore, the robot cleaner 200 may easily move to the wheel coupling portion 121c while passing over the inclined portion 121b.

The wheel coupling portions 121c may be disposed at stop positions of the left and right wheels 260 of the robot cleaner 200 so that the robot cleaner 200 is stopped at an exact position. In this case, the stop position of the wheel 260 refers to a position determined so that the robot cleaner 200 is stopped to be coupled to the electric power supply terminal 123b and/or a position determined so that the dust bin 220 of the robot cleaner 200 is stopped to communicate with the dust passage hole 123a.

A shape of the wheel coupling portion 121c may be a shape, i.e., an arcuate shape corresponding to a shape of the wheel 260 of the robot cleaner 200. With this configuration, the robot cleaner 200 may move along the wheel guide portion 121ba and be stopped at the same time when the wheel 260 is inserted into the wheel coupling portion 121c, and the wheel 260 may be stably seated on the wheel coupling portion 121c having an arcuate shape.

At least a part of the agitator 250 of the robot cleaner 200 may be accommodated in the agitator accommodation portion 121d. Specifically, the agitator accommodation portion 121d may provide a space in which a lower end of the agitator 250 of the robot cleaner 200 is accommodated in the state in which the wheels 260 of the robot cleaner 200 are seated on the wheel coupling portions 121c.

The agitator accommodation portion 121d may be formed between the wheel coupling portions 121c. The agitator accommodation portion 121d may be formed in a shape corresponding to the agitator 250 of the robot cleaner 200. The agitator accommodation portion 121d may be formed in a rectangular parallelepiped shape opened at an upper side thereof. A lower surface of the agitator accommodation portion 121d may be sealed by a bottom surface of the base main body 121a or a bottom surface of the housing 110. Therefore, the agitator 250 of the robot cleaner 200, which is moved upward along the inclined portion 121b, may be seated in a depressed portion 121da through the opened upper side of the agitator accommodation portion 121d. In this case, a depth of the depressed portion 121da may be smaller than a depth of the wheel coupling portion 121c.

The agitator accommodation portion 121d may include the depressed portion 121da and a protruding portion 121db.

The depressed portion 121da may be depressed in the base 121. The depressed portion 121da may define an accommodation space in which at least a part of the agitator 250 is accommodated. Therefore, at least a part of the agitator 250 may be accommodated in the accommodation space of the depressed portion 121da in the state in which the wheel 260 of the robot cleaner 200 is seated on the wheel coupling portion 121c.

The accommodation space of the depressed portion 121da may communicate with the accommodation space S of the seating part 120.

The protruding portion 121db may protrude from the base 121. The protruding portion 121db may be disposed along a rim of the depressed portion 121da. In addition, the protruding portion 121db may be disposed to be spaced apart from the body 210 of the robot cleaner 200 at a predetermined distance in the state in which the agitator 250 is accommodated in the accommodation space of the depressed portion 121da.

The protruding portion 121db may guide air, which is discharged through the air return port 125b, to the suction part 211 of the robot cleaner 200. Therefore, the air discharged to the accommodation space of the depressed portion 121da may be guided by the protruding portion 121db to the suction part 211 of the robot cleaner 200.

The air return port 125b may be formed in the agitator accommodation portion 121d. The air return port 125b may be formed in a lateral surface of the agitator accommodation portion 121d. The air return port 125b may connect a depressed portion 121da and the dust collection motor 145 through the return flow path. The depressed portion 121da and the return flow path may communicate with each other through the air return port 125b. Therefore, the air discharged from the dust collection motor 145 may pass through the air return port 125b and be discharged to the depressed portion 121da of the agitator accommodation portion 121d.

The coupling wall 123 is a component in which the dust passage hole 123a, the electric power supply terminal 123b, and a water supply nozzle 123c of the robot cleaner station 100 are disposed. The coupling wall 123 may spatially distinguish the accommodation space S from components of the robot cleaner station 100. The coupling wall 123 may extend in the vertical direction from a rear side of the base 121. The coupling wall 123 may be formed to correspond to a shape of the robot cleaner 200. For example, in case that the body 210 of the robot cleaner 200 has a cylindrical shape, the coupling wall 123 may be formed in a circular arc shape having a predetermined radius. With this configuration, it is possible to increase an area that may surround an outer periphery of the robot cleaner 200 and face the outer surface of the robot cleaner 200. In addition, the robot cleaner 200 may be stably supported.

The seating part 120 may be formed with the dust passage hole 123a through which air existing outside the housing 110 may be introduced into the housing 110. Specifically, the dust passage hole 123a may be formed in the coupling wall 123 so that outside air may be introduced into the housing 110. In this case, the dust passage hole 123a may be disposed at a rear side of the dust collection part housing 141 to be described below.

The dust passage hole 123a may communicate with the dust bin 220 of the robot cleaner 200. The dust passage hole 123a may communicate with the dust discharge port 221 of the dust bin 220 of the robot cleaner 200. The dust passage hole 123a may be formed in the form of a hole corresponding to a shape of the dust bin 220 so that the dust in the dust bin 220 may be introduced into the dust collection part 140. The dust passage hole 123a may be formed to correspond to a shape of the dust discharge port 221 of the dust bin 220.

The dust passage hole 123a may be formed to communicate with dust collection flow paths 147 and 148. The air sucked into the dust passage hole 123a may flow along the dust collection flow paths 147 and 148 and then be discharged through an air return part 125.

The robot cleaner station 100 may include an electric power supply module configured to supply electric power to the robot cleaner 200. The electric power supply module may include an electric power supply module housing and the electric power supply terminal 123b, and a circuit board and an element for supplying electric power may be mounted in the electric power supply module housing. Further, the electric power supply terminal 123b may be disposed forward in the electric power supply module housing and disposed on the coupling wall 123 so as to be exposed.

The electric power supply terminal 123b may supply electric power to the robot cleaner 200 coupled to the seating part 120. The electric power supply terminal 123b may come into contact with and be electrically connected to the charging terminal of the robot cleaner 200. The electric power supply terminal 123b may be disposed on the seating part 120. Specifically, the electric power supply terminal 123b may be disposed on the coupling wall 123. The electric power supply terminal 123b may be electrically connected to the robot cleaner 200 coupled to the coupling wall 123. The electric power supply terminal 123b may supply electric power to the battery of the robot cleaner 200 coupled to the coupling wall 123.

The robot cleaner station 100 may further include the water supply nozzle 123c.

The water supply nozzle 123c may be connected to the supply part 231 of the water container 230 of the robot cleaner 200. Specifically, the water supply nozzle 123c may be connected to the injection port of the water container 230. The injection port is configured to be connected to the water container 230 of the robot cleaner 200. The water supply nozzle 123c may supply water, which is supplied from the water supply pipe of the kitchen cabinet 2, to a storage space in the water container 230 of the robot cleaner 200.

The inner walls 124 is configured to spatially distinguish the accommodation space S of the seating part 120 from the components of the robot cleaner station 100. The inner walls 124 may be provided as a pair of inner walls 124 disposed at the left and right sides of the base 121. The inner walls 124 may be connected to two opposite ends of the coupling wall 123. The inner walls 124 may extend from the left and right sides of the base 121 in a direction intersecting the base 121. Specifically, the inner walls 124 may extend from the left and right sides of the base 121 in the vertical direction. A height of the inner wall 124 may correspond to a height of the pedestal 21. Specifically, the height of the inner wall 124 may be equal to the height of the pedestal 21.

Meanwhile, various types of components, such as the dust collection flow paths 147 and 148, the dust collection part 140, the dust collection motor 145, the detergent container 163, and a wastewater container 164 may be disposed outside the inner wall 124. Specifically, the dust collection part 140, the detergent container 163, and the wastewater container 164 may be accommodated in a space between the inner wall 124 and the outer wall 111 of the housing 110.

The dust collection part 140 and the detergent container 163 may be separated in a sliding manner from the space between the inner wall 124 and the outer wall 111 of the housing 110. Widths of the dust collection part 140 and the detergent container 163 in the leftward/rightward direction may correspond to a distance between the inner wall 124 and the outer wall 111 of the housing 110.

The washing plate 122 may be configured to wash the mop of the robot cleaner 200, and the washing plate 122 may be seated in the washing tub 128 of the base 121. In addition, the washing plate 122 may come into contact with the mop 242 in the state in which the robot cleaner 200 is seated.

The washing plate 122 may be a plate inclined downward toward a central portion thereof as a whole.

Specifically, the washing plate 122 includes a flow guide surface 122c formed as a curved surface. Further, one or more passing holes 122b through which the fluid may pass may be formed in the flow guide surface 122c. In addition, washing protrusions 122a may protrude from the flow guide surface 122c.

In this case, the washing protrusions 122a may be provided as a pair of washing protrusions 122a symmetrically formed on the flow guide surface 122c. Specifically, the pair of washing protrusions 122a may be disposed vertically below the pair of mops 242 of the robot cleaner 200 and disposed to face the pair of mops 242. The pair of washing protrusions 122a may be disposed to at least partially come into contact with the pair of mops 242.

Further, the passing holes 122b may be provided as a plurality of passing holes 122b formed in the flow guide surface 122c and formed between the pair of washing protrusions 122a. For example, the plurality of passing holes 122b may be formed while including positions on the flow guide surface 122c that have the lowest heights from the ground surface (the floor of the kitchen), and the plurality of passing holes 122b may be formed between the pair of washing protrusions 122a. Therefore, the fluid discharged between the pair of washing protrusions 122a may flow while being guided to the passing holes 122b.

Meanwhile, a height of the flow guide surface 122c from the floor of the kitchen may increase rearward from the position at which the passing holes 122b are formed. That is, the height of the flow guide surface 122c from the floor of the kitchen may increase as the distance from an outside air discharge part 171c to be described below decreases.

With this configuration, the flow of the washing water and/or air may be guided by the flow guide surface 122c, and the washing water and/or air may enter a space formed between the washing plate 122 and the washing tub 128 through the passing holes 122b. Therefore, the heated air may be supplied to the washing tub 128 through the passing hole 122b.

Therefore, the mops 242 are rotated when the drive part of the rotary cleaning part 240 operates in the state in which the mops 242 of the robot cleaner 200 are seated on the washing plate 122. In this case, when the mops 242 is rotated in the state in which washing water is supplied to the washing plate, the mops 242 may be washed by friction with the washing protrusions 122a provided in a stationary state.

The washing tub 128 is a component in which the washing plate 122 is seated. The washing tub 128 may be disposed rearward of the base main body 121a. The washing tub 128 may be disposed below the washing plate 122 and detachably coupled to the washing plate 122. The washing tub 128 may be formed to correspond to the washing plate 122 so as to be fitted with the washing plate 122. The liquid passing through the washing plate 122 may be introduced into the washing tub 128.

The washing tub 128 may include a washing tub base surface along which the fluid having passed through the washing plate 122 flows, and a washing tub wall extending and protruding in the vertical direction from an outer periphery of the washing tub base surface. In this case, a height of the washing tub base surface from the ground surface (the floor of the kitchen) may decrease toward the rear side of the robot cleaner station 100. Therefore, the fluid having passed through the washing plate 122 may be collected at a rear side of the washing tub 128 and discharged to the outside through a wastewater inlet port 164c to be described below.

### Dust Collection Part

The dust collection part 140 may collect dust from the dust bin 220 of the robot cleaner 200. The dust collection part 140 may be disposed in the housing 110. The dust collection part 140 may be disposed outside the seating part 120. That is, the dust collection part 140 may be disposed between the housing 110 and the seating part 120. For example, the dust collection part 140 may be disposed at one side of the seating part 120 based on a leftward/rightward direction.

The dust collection part 140 may include the dust collection part housing 141, a filter 142, a dust bag 143, the dust bag drawer 144, the dust collection motor 145, a dust collection motor housing 146, a first dust collection flow path 147, and a second dust collection flow path 148.

The dust collection part housing 141 may form a space in which the filter 142, the dust bag 143, and the dust bag drawer 144 may be accommodated.

The dust bag drawer 144, which may be withdrawn, may be coupled in the dust collection part housing 141, and the dust bag 143 may be accommodated in the dust bag drawer 144. For example, the dust collection part housing 141 may be provided in the form of a rectangular tube opened at a front side thereof, and a rear internal space may communicate with the first dust collection flow path 147 and the second dust collection flow path 148.

Dust in the dust bin 220 may be introduced into the dust collection part housing 141.

One side of the inside of the dust collection part housing 141 may communicate with the first dust collection flow path 147, and the other side of the inside of the dust collection part housing 141 may communicate with the second dust collection flow path 148. In addition, when the dust bag 143 is coupled to the dust collection part housing 141, the dust bag 143 may be disposed in the dust collection part housing 141 and communicate with the first dust collection flow path 147.

The filter 142 may be disposed in the dust bag drawer 144. Specifically, the filter 142 may be disposed in the dust bag drawer 144 and withdrawn together with the dust bag drawer 144.

Meanwhile, the filter 142 may be disposed to be lower than the inlet port 144b based on the bottom surface of the dust bag drawer body 144a. The filter 142 may be disposed forward of the outlet port 144c of the dust bag drawer 144.

Specifically, the filter 142 may be detachably coupled to the lower surface of the dust bag drawer 144. In this case, the filter 142 may be disposed at one end (front end) of the flow path forming portion 144e based on the longitudinal direction. Therefore, the filter 142 may be disposed between the handle 144d and the flow path forming portion 144e. That is, the filter 142 may be disposed adjacent to a front surface of the dust bag drawer 144.

When the dust bag drawer 144 is withdrawn, the filter 142 may be withdrawn together with the dust bag drawer 144. That is, when the handle 144d is pulled, the filter 142 may be withdrawn together with the dustbag drawer 144. In this case, because the filter 142 is disposed immediately rearward of the handle 144d, the user may easily replace the filter 142 even in a state in which only a part of the dustbag drawer 144 is withdrawn.

Meanwhile, the filter 142 may be disposed to be spaced apart from two opposite surfaces of the dustbag drawer 144 based on the leftward/rightward direction (width direction). That is, a space may be formed between the filter 142 and two opposite surfaces of the dustbag drawer body 144a based on the leftward/rightward direction. In this case, the user's finger may enter the space.

With this configuration, the user may separate the filter 142 by a simple operation of inserting the finger into the space between the filter 142 and the dustbag drawer body 144a and pulling the filter 142.

The filter 142 may be disposed below the dust bag 143. In this case, the dust bag 143 may be coupled to be detachable from the dust bag drawer 144 in the vertical direction in a sliding manner.

Therefore, the dust bag 143 may be separated in the vertical direction from the dust bag drawer 144 in the state in which the dust bag drawer 144 is withdrawn. The filter 142 may be exposed to the outside when the dust bag 143 is separated.

Therefore, the user may identify a state of the filter 142 each time the user replaces the dust bag 143. The user may easily replace the filter 142 while replacing the dust bag 143.

The dust bag 143 may refer to a dust collection bag configured to collect dust sucked from the interior of the dust bin 220 of the robot cleaner 200 by the dust collection motor 145.

The dust bag 143 may be detachably coupled to the dust bag drawer 144. Therefore, the dust bag 143 may be separated from the dust bag drawer 144 and discarded, and a new dust bag 143 may be coupled to the dust bag drawer 144. That is, the dust bag 143 may be defined as a consumable component.

An inlet port of the dust bag 143 may be disposed to communicate with the inlet port 144b of the dust bag drawer 144. Therefore, when the dust collection motor 145 operates, air and dust in the dust bin 220 may be introduced into the dust bag 143 and captured.

When a suction force is generated by the dust collection motor 145, a volume of the dust bag 143 is increased, such that the dust may be accommodated in the dust bag 143. To this end, the dust bag 143 may be made of a material that transmits air but does not transmit debris such as dust. For example, the dust bag 143 may be made of a non-woven fabric material and have a hexahedral shape corresponding to a shape of the dust bag drawer 144 when the bag 143 has an increased volume.

The dust collection part 140 may further include a dust collection module. The dust collection module may provide a suction gas flow to the dust collection flow path.

Specifically, the dust collection part 140 may further include the dust collection motor 145 and the dust collection motor housing 146.

The dust collection motor 145 may generate a suction force in the dust collection flow paths 147 and 148. That is, the dust collection motor 145 may provide a suction force that sucks the dust in the dust bin 220 into the dust bag 143 disposed in the dust collection part housing 141.

The dust collection motor 145 may be disposed rearward of the dust collection part housing 141. Therefore, the dust collection motor 145 may provide a suction force capable of sucking dust in the dust bin 220 of the robot cleaner 200.

The dust collection motor 145 may generate the suction force by means of the rotation. For example, although not illustrated, the dust collection motor 145 may include a rotor and a stator that perform a relative rotation by receiving electric power, and the dust collection motor 145 may include an impeller configured to be rotated about a rotary shaft by the rotation of the rotor. Therefore, the suction force may be generated by the rotation of the impeller.

One side of the dust collection motor 145 may be connected to the second dust collection flow path 148, and the other side of the dust collection motor 145 may be connected to the return flow path 125a. In case that the dust collection motor 145 operates, the air flowing through the second dust collection flow path 148 may be introduced into the dust collection motor housing 146. In addition, the air introduced into the dust collection motor housing 146 may pass through the dust collection motor 145 and then flow through the return flow path 125a.

Meanwhile, in the present embodiment, a rotary shaft of the dust collection motor 145 may be disposed in the vertical direction. In this case, it is possible to minimize a horizontal space occupied by the dust collection motor 145.

Meanwhile, in case that the rotary shaft of the dust collection motor 145 is disposed in the vertical direction, a side at which the air is introduced into the dust collection motor 145 and a side at which the air is discharged from the dust collection motor 145 may be disposed at different heights. Therefore, a structure of the dust collection motor housing 146 may be formed.

The dust collection motor 145 may be accommodated in the dust collection motor housing 146. The dust collection motor housing 146 may be disposed rearward of the dust collection part housing 141. In addition, the dust collection motor housing 146 may be disposed rearward of the first dust collection flow path 147. In addition, the dust collection motor housing 146 may be disposed rearward of the second dust collection flow path 148.

That is, based on the forward/rearward direction of the robot cleaner station 100, the dust collection part housing 141 may be disposed at a foremost side, and the first dust collection flow path 147 and the second dust collection flow path 148 may be disposed rearward of the dust collection part housing 141. In addition, the dust passage hole 123a may be disposed rearward of the first dust collection flow path 147, and the dust collection motor housing 146 may be disposed rearward of the second dust collection flow path 148. In addition, the dust collection motor housing 146 may be disposed rearward of the dust passage hole 123a.

Therefore, the dust collection part 140 may be disposed in the forward/rearward direction of the robot cleaner station 100, as a whole, thereby reducing an overall height.

Meanwhile, the dust collection part 140 may further include the dust collection flow paths 147 and 148. The dust collection flow path may refer to a flow path through which the air sucked through the dust passage hole 123a flows to the dust collection motor 145 via the dust bag.

Specifically, the dust collection flow path may include the first dust collection flow path 147 configured to allow the dust bin 220 and an internal space of the dust collection part housing 141 to communicate with each other when the robot cleaner 200 is coupled to the robot cleaner station 100 and the dust passage hole 123a and the dust bin 220 of the robot cleaner 200 communicate with each other, and the second dust collection flow path 148 configured to allow the internal space of the dust collection part housing 141 and an internal space of the dust collection motor housing 146 to communicate with each other.

The first dust collection flow path 147 may connect the dust bin 220 of the robot cleaner 200 and the internal space of the dust collection part housing 141. The first dust collection flow path 147 may connect the dust passage hole 123a of the seating part 120 and the internal space of the dust collection part housing 141. The first dust collection flow path 147 may be formed in a direction intersecting the vertical direction. For example, the first dust collection flow path 147 may be formed to be close to the horizontal direction. The first dust collection flow path 147 may be a space formed rearward of the dust passage hole 123a. The first dust collection flow path 147 may be a flow path bent laterally from the dust passage hole 123a, and the dust and the air may flow through the first dust collection flow path 147. The dust in the dust bin 220 of the robot cleaner 200 may move to the internal space of the dust collection part housing 141 through the first dust collection flow path 147.

The second dust collection flow path 148 may connect the internal space of the dust collection part housing 141 and the internal space of the dust collection motor housing 146. The second dust collection flow path 148 may be formed in a direction intersecting the vertical direction. For example, the second dust collection flow path 148 may be formed to be close to the horizontal direction.

In this case, in the present disclosure, the first dust collection flow path 147 and the second dust collection flow path 148 may be formed at different heights. That is, the first dust collection flow path 147 and the second dust collection flow path 148 may be disposed as layered structures. At least a part of the first dust collection flow path 147 may be disposed above the second dust collection flow path 148.

With this configuration, the plurality of flow paths may be disposed to be close to the horizontal direction, thereby reducing an overall height, and simultaneously, the plurality of flow paths may be stacked, thereby minimizing an overall volume and width of the robot cleaner station 100 in the leftward/rightward direction.

### Mop Washing Part

The robot cleaner station 100 according to the embodiment of the present disclosure may include the mop washing part 160. The mop washing part 160 may wash the mops 242 of the robot cleaner 200 coupled to the seating part 120.

The mop washing part 160 may include washing water supply parts 161 configured to discharge the washing water to the washing plate 122, the detergent container 163 configured to store the liquid containing the detergent, and the wastewater container 164 configured to store the washing water that has been used to wash the mops 242.

The washing water supply parts 161 may produce the washing water by mixing purified water and the detergent to wash the mops 242.

The washing water supply part 161 includes a branch flow path 161a, a purified water inlet port 161b, a detergent inlet port 161c, a detergent pump 161d, and washing water discharge ports 161e.

In this case, the washing water discharge ports 161e may be provided as a pair of washing water discharge ports 161e disposed rearward of the coupling wall 123 and spaced apart from each other. The washing water discharge port 161e may discharge the washing water toward the washing plate 122 from above the washing plate 122. For example, the pair of washing water discharge ports 161e may be disposed above the pair of washing protrusions 122a.

In this case, the purified water, which is supplied from the water supply pipe of the kitchen cabinet 2 and passes through a regulator 162, may be connected to the washing water discharge ports 161e diverged at two opposite sides through the branch flow path 161a and disposed to be spaced apart from each other. That is, the branch flow path 161a may be provided in a shape having two tube portions diverged from a single tube portion. In this case, an end of one diverged tube portion may be connected to any one of the pair of washing water discharge ports 161e, and an end of the other diverged tube portion may be connected to the remaining one of the pair of washing water discharge ports 161e. Therefore, the branch flow path 161a may supply the washing water to the pair of washing water discharge ports 161e.

The washing water discharge port 161e may be formed rearward of the coupling wall 123 and integrated with the coupling wall 123, or the washing water discharge port 161e may be separably coupled to the coupling wall 123.

The purified water inlet port 161b is configured to guide the purified water, which is supplied from the water supply pipe of the kitchen cabinet 2, to the washing water supply part 161. Specifically, the water supply pipe of the kitchen cabinet 2 may be connected to the regulator 162 and adjust a flow rate of the water supplied from the water supply pipe. In addition, a part of the purified water having passed through the regulator 162 may be supplied to the water container 230 of the robot cleaner 200 through the water supply nozzle 123c, and the remaining purified water may be introduced into the pair of washing water supply parts 161, which are disposed to be spaced apart from each other, through the purified water inlet port 161b.

The detergent inlet port 161c is configured to guide the liquid, which contains the detergent supplied from the detergent container 163, to the washing water supply part 161. Specifically, the liquid containing the detergent stored in the detergent container 163 may be supplied to the washing water supply part 161 by means of the detergent pump 161d.

In addition, the detergent and the purified water, which are introduced into the washing water supply part 161, may be mixed and utilized as the washing water. The washing water supply part 161 may discharge the washing water to an upper surface of the washing plate 122 through the washing water discharge port 161e. The washing water discharge port 161e may be opened in a direction in which the washing water discharge port 161e faces an upper surface of the mop 242 seated on the washing plate 122.

The detergent container 163 may store the liquid containing the detergent.

The detergent container 163 includes a detergent container body 163a, a handle 163b, and detergent container rails 163c (see the drawings).

The detergent container body 163a may provide a space that may store the liquid containing the detergent. For example, the detergent container body 163a may be provided in the form of a box opened at an upper side thereof, and a rear side of the detergent container body 163a may be connected to the washing water supply part 161.

The handle 163b may be provided forward of the detergent container body 163a. The handle 163b may be configured to be gripped by the user. For example, the handle 163b may include a pair of coupling portions hingedly coupled to a front surface of the detergent container body 163a, and a grip portion formed to connect the pair of coupling portions and configured to be gripped by the user.

With this configuration, when the user grips the grip portion and pulls the handle forward, the detergent container body 163a may be extracted by being pulled forward together with the handle. Therefore, according to the present disclosure, the user may easily pull the detergent container 163 forward, and then the detergent may be supplied.

The detergent container rails 163c may be formed on lateral surfaces of the detergent container body 163a based on the leftward/rightward direction. The detergent container rail 163c may guide a movement of the detergent container body 163a.

For example, the detergent container rails 163c may be provided in the form of grooves or ribs in the forward/rearward direction on the lateral surfaces of the detergent container body 163a based on the leftward/rightward direction.

With this configuration, in case that the user couples the detergent container 163 to the housing 110, the detergent container 163 may be coupled at an exact position, and the washing water may be prevented from leaking out.

Meanwhile, although not illustrated, rails may be formed on the housing 110 while corresponding to the detergent container rails 163c. The rails may be formed to correspond to shapes and positions of the detergent container rails 163c.

The wastewater container 164 may provide a space that stores the washing water that has been used to wash the mop 242. After the mop 242 is washed, the washing water discharged to the upper surface of the washing plate 122 may flow downward along the inclination of the washing plate 122 and be discharged to the passing holes 122b. The washing water having passed through the passing holes 122b accumulates in the washing tub 128. In addition, the washing water accumulating in the washing tub 128 may be introduced into a wastewater suction flow path 164b through a wastewater inlet port 164c, pass through the wastewater suction flow path 164b, and be introduced into the wastewater container 164. That is, the liquid having passed through the washing plate 122 may flow along the washing tub 128 and be discharged through the wastewater inlet port 164c.

Meanwhile, the wastewater suction flow path 164b is formed in a wastewater suction pipe, the wastewater inlet port 164c is formed at one end of the wastewater suction pipe, and the other end of the wastewater suction pipe communicates with the wastewater container 164. In this case, the wastewater suction pipe may be disposed to pass through a lower side of an outside air supply module 171. That is, the wastewater suction flow path 164b may be disposed below the outside air supply module 171. In addition, the wastewater suction flow path 164b may be disposed below an outside air supply flow path 171a.

The washing water stored in the wastewater container 164 may be discharged to the water drain pipe 25 of the kitchen cabinet 2 through a wastewater discharge flow path 164a. One end of the wastewater discharge flow path 164a may be connected to the wastewater container 164, and the other end of the wastewater discharge flow path 164a may be connected to the water drain pipe 25. In this case, the washing water stored in the wastewater container 164 may be allowed to flow through the wastewater discharge flow path 164a by a centrifugal pump (not illustrated) and discharged to the water drain pipe.

The wastewater discharge flow path 164a connected to the wastewater container 164 may be connected to the upstream side 25b based on the U-trap 25a of the water drain pipe 25 of the kitchen cabinet 2. This is because an offensive odor or fluid in the water drain pipe 25 may flow reversely to the wastewater discharge flow path 164a in case that the wastewater discharge flow path 164a is connected to the downstream side 25c based on the U-trap 25a of the water drain pipe 25.

In addition, the mop washing part 160 may include a check valve (not illustrated). The check valve may prevent the fluid in the water drain pipe 25 from flowing reversely to the wastewater discharge flow path 164a. The check valve may be provided at the other end of the wastewater discharge flow path 164a connected to the water drain pipe 25.

Meanwhile, the detergent container 163 and the wastewater container 164 may be accommodated in a space formed between the inner wall 124 and the outer wall 111 of the housing. The detergent container 163 may be disposed at a lower side of the space formed between the inner wall 124 and the outer wall 111 of the housing, and the wastewater container 164 may be disposed above the detergent container 163 and disposed at an upper side of the space formed between the inner wall 124 and the outer wall 111 of the housing.

### Mop Drying Part

The mop drying part 170 according to the embodiment of the present disclosure may include an outside air supply module 171, an air discharge part 172, a drying fan 173, and a check valve 175.

The outside air supply module 171 may supply hot air to an accommodation space S and include an outside air supply flow path 171a, an outside air inlet port 171b, an outside air discharge part 171c, a heater 171d, and a blower fan 171e.

The outside air supply module 171 is formed with the outside air supply flow path 171a. The outside air supply flow path 171a may allow outside air to flow to the outside air discharge part 171c.

The outside air supply flow path 171a may connect the external space of the housing 110 and the accommodation space S. One side of the outside air supply flow path 171a may communicate with the external space through the outside air inlet port 171b, and the other side of the outside air supply flow path 171a may communicate with the accommodation space S through the outside air discharge part 171c.

The outside air inlet port 171b may be formed in a rear surface of the housing 110. The outside air inlet port 171b may be provided as a plurality of outside air inlet ports 171b formed in the rear surface of the housing 110. The air existing outside the housing 110 may be introduced into the outside air supply flow path 171a through the outside air inlet port 171b. Therefore, the air existing outside the housing 110 may be introduced into the housing 110.

At least a part of the outside air discharge part 171c may be disposed above the washing plate 122. The outside air discharge part 171c may be open in a direction facing the washing plate 122. The outside air discharge part 171c may be provided as a pair of outside air discharge parts 171c opened at lower sides thereof.

The outside air discharge part 171c may discharge the air having passed through the outside air supply flow path 171a. The outside air discharge part 171c may discharge the air heated by the heater 171d. For example, the outside air discharge part 171c may be formed with an outside air outlet port.

The outside air discharge part 171c may be open toward the upper surface of the mop 242 in the state in which the mop 242 is seated on the washing plate 122. Therefore, the outside air discharge part 171c may be positioned adjacent to the mop 242 and open downward, such that the air discharged from the outside air discharge part 171c may flow toward the mop 242.

The blower fan 171e may be disposed in the outside air supply flow path 171a and blow the air toward the accommodation space S. When the blower fan 171e operates, the air introduced through the outside air inlet port 171b may be heated by the heater 171d and discharged to the accommodation space S through the outside air discharge part 171c.

The heater 171d may be disposed in the outside air supply flow path 171a and heat the air flowing through the outside air supply flow path 171a. The heater 171d may heat the air discharged through the outside air discharge part 171c.

The heater 171d may include a heater housing and a heating element. In this case, the heater housing may be disposed in the outside air supply flow path 171a and have a space in which the heating element may be accommodated. In addition, the heating element may heat air to be introduced into the heater housing. Therefore, the air heated by the heating element may be discharged to the accommodation space S through the outside air discharge part 171c and dry the wet mop 242.

The air discharge part 172 may discharge high-temperature, humid air, which is produced in the robot cleaner station 100 when the mop 242 is dried, to the water drain pipe 25. Specifically, the air discharge part 172 may connect the accommodation space S and the water drain pipe 25 of the kitchen cabinet 2.

The air discharge part 172 may be formed with an air discharge flow path. In this case, one end of the air discharge flow path may be connected to the accommodation space S, and the other end of the air discharge flow path may be connected to the water drain pipe 25. Specifically, an air suction port 172a, which is one end of the air discharge flow path, may be connected to the accommodation space S, and an air outlet port 172b, which is the other end of the air discharge flow path, may be connected to the water drain pipe 25.

Meanwhile, the air suction port 172a may be disposed at various positions on the accommodation space S. For example, the air suction port 172a may be disposed in the coupling wall 123. In another example, the air suction port 172a may be disposed in the inner wall 124. In still another example, the air suction port 172a may be disposed to be higher than the mop 242 from the ground surface and disposed forward of the outside air discharge part 171c. Therefore, it is possible to discharge vapor-containing air produced during the process of drying the mop 242.

The air discharge part 172 may be connected to the downstream side 25c based on the U-trap 25a of the water drain pipe 25 of the kitchen cabinet 2. This is because hot air discharged through the air discharge part 172 cannot pass through the water drain pipe 25 because of the water accumulated in the U-trap 25a in case that the air discharge part 172 is connected to the upstream side 25b based on the U-trap 25a of the water drain pipe 25.

Meanwhile, the air discharge flow path according to the embodiment of the present disclosure may be configured such that two tube portions are diverged from a single tube portion in the housing 110 and penetrate two opposite sides of the housing 110. In this case, any one diverged tube portion may penetrate a left outer wall surface of the housing 110, and the other diverged tube portion may penetrate a right outer wall surface of the housing 110. The air discharge part 172, which penetrates the two opposite outer walls 111 of the housing 110, may be connected to the water drain pipe 25. Therefore, the air sucked from the air discharge part 172 may flow through the air outlet port 172b divided into two opposite sides and be discharged to the downstream side 25c based on the U-trap 25a of the water drain pipe 25.

The drying fan 173 may discharge the air, which is introduced through the air suction port 172a, to the water drain pipe 25. The drying fan 173 may allow the air introduced into the air discharge part 172 to flow. The drying fan 173 may be disposed on an air discharge flow path part.

When the drying fan 173 operates, the air in the accommodation space S may be introduced into the air suction port 172a. The air introduced into the air suction port 172a may flow through the air discharge part 172 and be discharged to the water drain pipe 25. Specifically, when the drying fan 173 operates, the air flowing through the air discharge part 172 may be discharged to the downstream side 25c based on the U-trap 25a of the water drain pipe 25.

The mop drying part 170 may include the check valve 175. The check valve 175 may be provided at the other end of the air discharge flow path connected to the water drain pipe 25. Therefore, it is possible to prevent the fluid in the water drain pipe 25 from flowing reversely to the air discharge part 172.

### Inner Frame

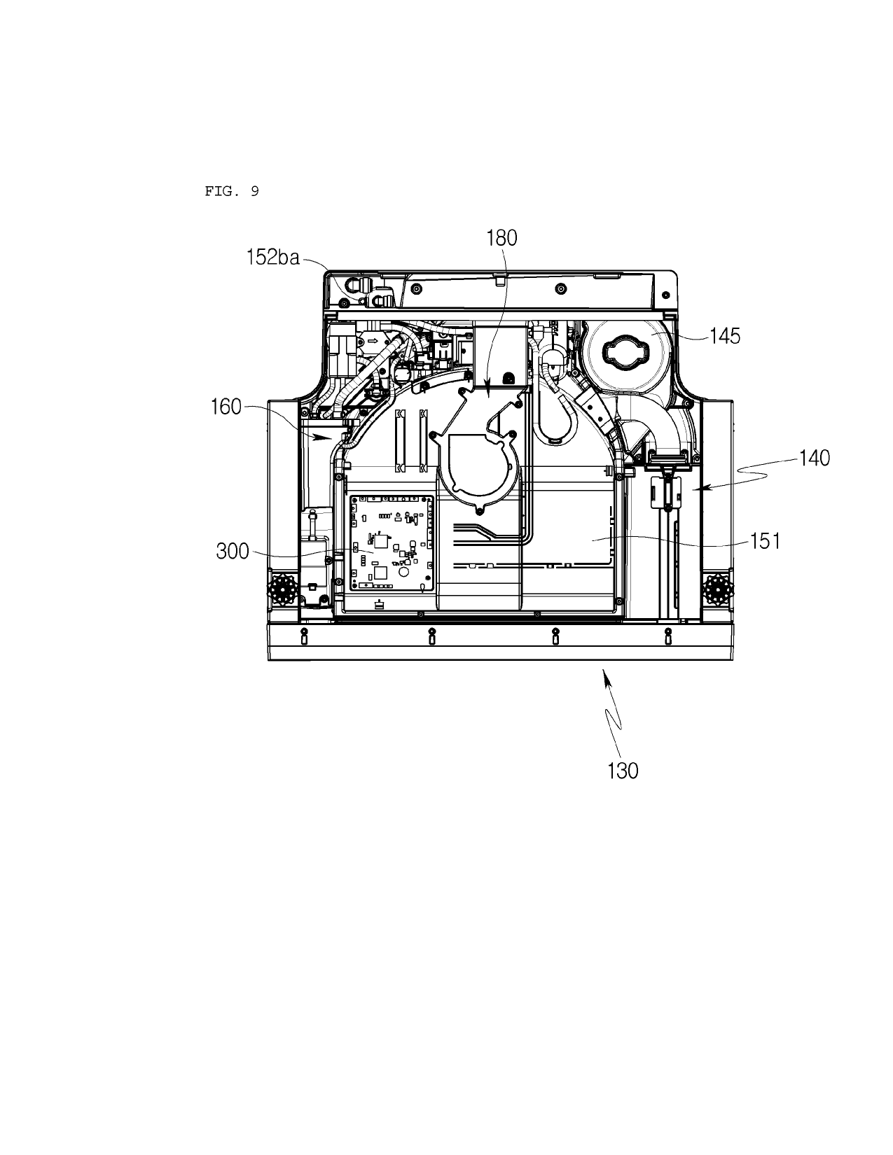

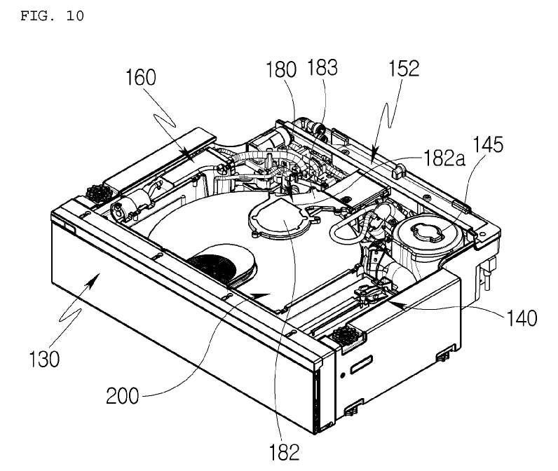

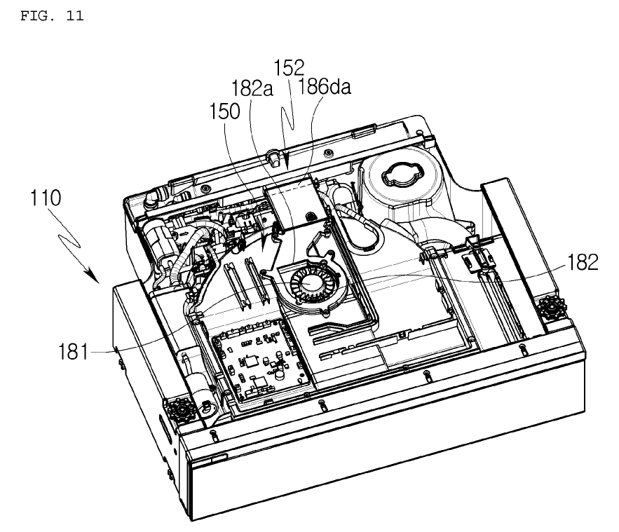

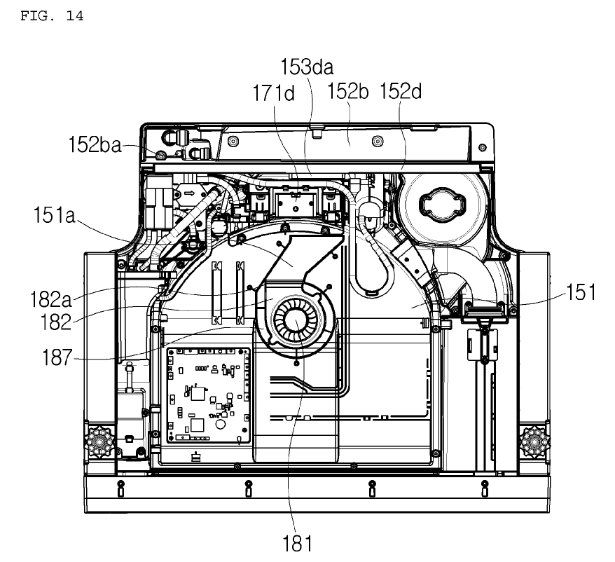

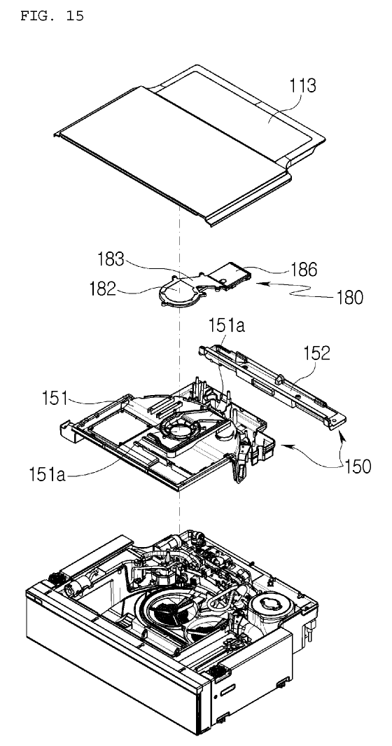

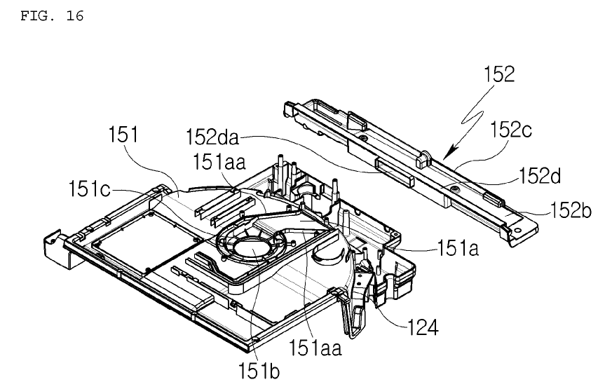

FIGS. 9 to 13 are views for explaining an internal structure of the robot cleaner station according to the embodiment of the present disclosure, FIG. 14 is a view for explaining a flow path forming portion of the robot cleaner station according to the embodiment of the present disclosure, FIG. 15 is an exploded perspective view illustrating the robot cleaner station according to the embodiment of the present disclosure, and FIG. 16 is a view for explaining an inner frame of the robot cleaner station according to the embodiment of the present disclosure.

An inner frame of the robot cleaner station according to the embodiment of the present disclosure will be described below with reference to FIGS. 9 and 16.

First, hereinafter, a structure of the robot cleaner station, which discharges wet vapor existing in the robot cleaner station, will be described, and the terms "wet vapor" and "condensate water" will be defined. Hereinafter, the term "wet vapor" refers to moisture-containing air in the robot cleaner station, and the term "condensate water" refers to water obtained by condensing the "wet vapor".

An inner frame 150 may be disposed above the base 121. The inner frame 150 may be provided in the form of a plate that covers the upper side of the robot cleaner station 100 in the horizontal direction of the robot cleaner station 100.

The inner frame 150 may include an upper surface 151 configured to cover an upper side of the base 121, and an upper rear cover 152 positioned rearward of the upper surface 151 and configured to cover an upper side of an internal configuration of the robot cleaner station.

The inner frame 150 may be provided with the upper surface 151 configured to cover an upper side of the seating part 120, and an edge of the upper surface 151 may be connected to the coupling wall 123 and the inner wall 124 of the seating part 120.

Therefore, the upper surface 151a, the coupling wall 123, the inner wall 124, and the base 121 may define a space that accommodates the robot cleaner 200 when the robot cleaner 200 enters the robot cleaner station 100.

The upper surface 151 may be formed with a exhaust fan mounting groove 151c in which a exhaust fan housing 182 to be described below may be positioned. The exhaust fan mounting groove 151c may be in contact with a part of a lower surface of the exhaust fan housing 182.

A exhaust fan 181 may be positioned in the exhaust fan housing 182, and a wet vapor inlet hole 151b may be formed at a lower side of the exhaust fan housing 182 so that wet vapor existing in the seating part 120 may be introduced. For example, the wet vapor inlet hole 151b may be a circular hole formed by boring the upper surface 151a.

The wet vapor inlet hole 151b may be positioned in a central portion of the seating part 120. In this case, when the robot cleaner station 100 is viewed from above, the central portion may be an area between one-third point and two-thirds point of a horizontal length and an area between one-third point and two-thirds point of a vertical length. However, the position of the wet vapor inlet hole 151b is not limited thereto.

Therefore, in order to wash or dry the mop, the wet vapor may be discharged to the wet vapor inlet hole 151b immediately after the wet vapor is introduced from the coupling wall 123. In addition, the wet vapor, which moves to the door part 130 without being discharged, may also be introduced into the wet vapor inlet hole 151b.

That is, even though wet vapor exists at any position in the robot cleaner station 100, the wet vapor may be introduced into the wet vapor inlet hole 151b.

In addition, the upper surface 151 may include a flow path forming portion 151a positioned below a discharge part cover 183.

The exhaust fan housing 182 may be positioned at one side of the flow path forming portion 151a. Specifically, the flow path forming portion 151a may be positioned rearward of a wet vapor outlet port 182a of the exhaust fan housing 182 so that the wet vapor discharged from the exhaust fan 181 may flow.

The flow path forming portion 151a may be formed to define a stepped portion together with the upper surface 151. More specifically, a bottom surface of the flow path forming portion 151a may be formed at a position relatively lower than the upper surface 151.

Therefore, the portion where the stepped portion is formed may be formed with a flow path forming portion sidewall 151aa formed by bending the upper surface 151a downward.

The flow path forming portion 151a may be formed to be inclined downward and rearward based on the exhaust fan 181, and the wet vapor may flow rearward through the flow path forming portion 151a.

In addition, the flow path forming portion 151a may be formed to be curved leftward or rightward. In other words, a longitudinal surface of a wall formed by bending the upper surface 151a downward may be formed in a gradually curved shape.

For example, when the flow path forming portion 151a is formed to be curved in a direction in which the exhaust fan rotates, it is possible to improve efficiency in discharging wet vapor by preventing a turbulent flow caused when wet vapor discharged from the exhaust fan collides with the wall.

Meanwhile, the upper surface 151a may be formed with a plurality of coupling grooves so that the upper surface 151a may be coupled to a exhaust fan cover 183. A bolt is inserted into the coupling groove and coupled to the exhaust fan cover, such that the discharge part cover 183 may be fixed to the upper surface 151.

The upper rear cover 152 may be positioned above the blower fan 171e and rearward of a discharge part 180 and connected to the left and right outer wall surfaces of the housing 110. Therefore, the upper rear cover 152 may cover a portion ranging from a rear end of the discharge part 180 to a rear outer wall surface of the housing 110.

The upper rear cover 152 may include a partition wall 153 into which a rear end of a discharge pipe 186 to be described below is inserted.

The partition wall 153 may be provided in the form of a plate that is perpendicular to the longitudinal direction of the discharge pipe 186 and extends in the leftward/rightward direction. A space may be formed between the left and right ends of the partition wall 153 and the outer wall surface of the housing 110. A protruding portion protruding from an end of an upper cover 113 may be inserted into the space. Therefore, the upper cover 113 may be fixed to the upper portion of the housing 110.

A longitudinal direction of the partition wall 153 may be the leftward/rightward direction, and a height direction of the partition wall 153 may be the upward/downward direction. A height of the partition wall 153 may be larger than a vertical diameter of the discharge pipe 186.

The partition wall 153 may be provided with a discharge pipe insertion groove 153da into which the rear end of the discharge pipe 186 may be inserted. The discharge pipe insertion groove 153da may be formed to correspond to an outer peripheral surface of the discharge pipe 186.

For example, when the outer peripheral surface of the discharge pipe 186 is formed in a quadrangular shape, the discharge pipe insertion groove 153da may also be formed in a quadrangular shape.

The upper rear cover 152 may further include a bent portion 152a, a cover bottom surface 152b, and a rear rib 152c.

The bent portion 152a may be positioned below a partition wall 152d and bent downward from the rear end of the discharge pipe 186. The bent portion 152a may be connected to a lower end of the partition wall 152d and extend downward from the lower end of the partition wall 152d.

The cover bottom surface 152b may be positioned above the blower fan 171e. In addition, the cover bottom surface 152b may extend rearward from a lower end of the bent portion 152a and be formed to be inclined upward and rearward.

Therefore, the condensate water discharged from the discharge pipe 186 may flow downward along the bent portion 152a.

If a flow velocity of the condensate water flowing along the discharge pipe 186 increases, the condensate water discharged from the discharge pipe 186 may not flow along the bent portion 152a sometimes.

However, because the cover bottom surface 152b is formed to be inclined upward and rearward, the condensate water falling onto the cover bottom surface 152b may flow forward again. That is, the condensate water may be collected at a point at which the bent portion 152a and the cover bottom surface 152b are connected.

The cover bottom surface 152b may further include a drain hole 152ba through which the condensate water is discharged. The drain hole 152ba may be positioned on the cover bottom surface 152b close to the bent portion 152a and positioned at the left or right side of the cover bottom surface 152b.

In addition, the cover bottom surface 152b may be formed to be inclined downward in a direction in which the drain hole 152ba is positioned, and a pipe through which the condensate water may be discharged to the washing tub 128 may be connected to a lower side of the drain hole 152ba.

Therefore, the condensate water collected at the point at which the bent portion 152a and the cover bottom surface 152b are connected may flow in a direction toward the drain hole 152ba, and the condensate water introduced into the drain hole 152ba may be discharged to the washing tub 128.

A rear end of the cover bottom surface 152b may be connected to a rear outer wall surface of the housing 110, and the rear rib 152c may protrude rearward from the cover bottom surface 152b.

An upper portion of the rear rib 152c may be coupled to a portion bent downward from a rear side of the upper cover 113. Therefore, a space surrounded by the upper rear cover 152 and the upper cover 113 may be formed. In this case, left and right sides of the space may be open.

Because the left and right sides of the space are open, a water drain connection pipe 165b may be connected to the water drain pipe 25 of the kitchen cabinet 2, and a water supply connection pipe 165a may be connected to the water supply pipe of the kitchen cabinet 2.

In addition, the space may be opened so that ambient air may be introduced into the discharge part 180. Therefore, the wet vapor discharged through the discharge part 180 may be diluted with ambient air having a relatively low temperature, and the wet vapor, which comes into contact with the ambient air, may be condensed into condensate water.

In addition, wet vapor, which is not condensed into condensate water, may be discharged through the space.

In general, because a rear side of the robot cleaner station 100 is installed in a direction toward a wall surface of the space, wet vapor may come into contact with a wall surface having a relatively low temperature in case that the wet vapor is discharged rearward, and moisture may be formed. That is, in case that the wet vapor is discharged rearward, moisture is supplied to the wall surface, and bacteria, such as mold, may inhabit, which causes a concern that an offensive odor may be generated, and the wall surface of the space may be damaged.

However, in the robot cleaner station 100 of the present disclosure, the housing 110 may have the space opened at the left and right sides thereof so that wet vapor may be discharged to the left and right sides, thereby solving the above-mentioned problems.

### Discharge Part

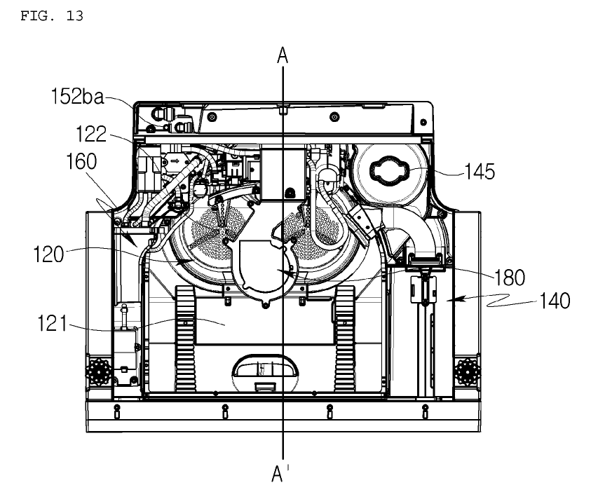

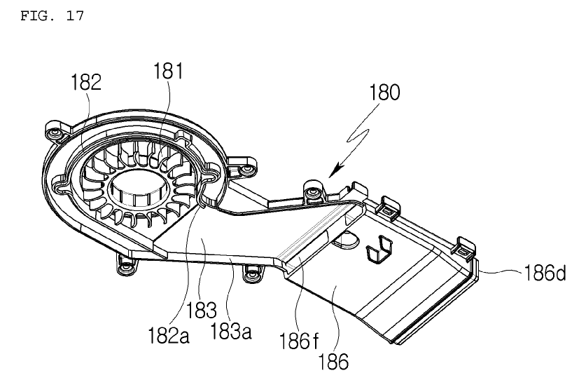

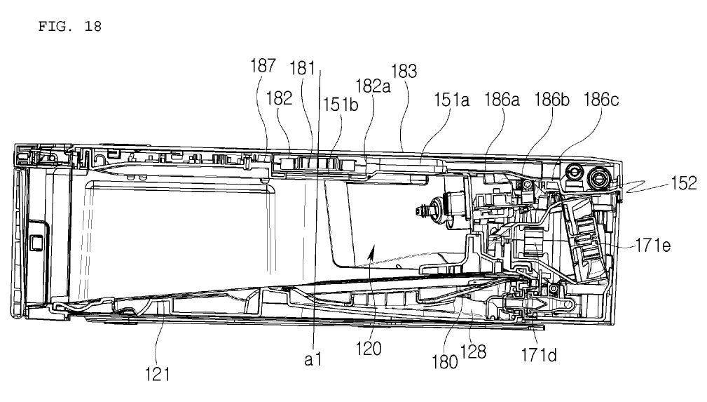

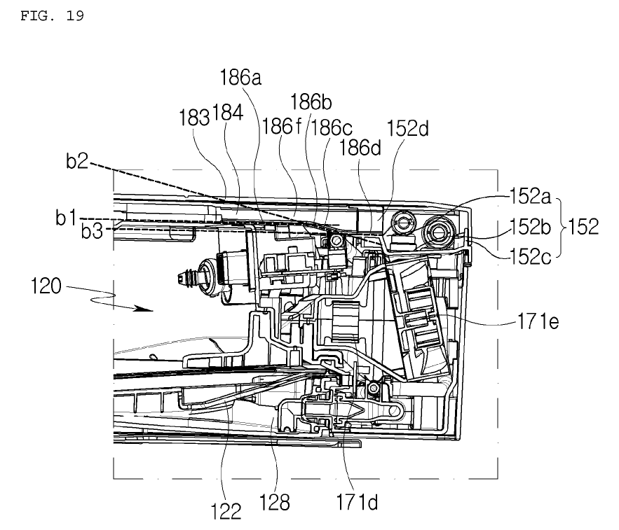

FIG. 12 is a view for explaining a discharge part of the robot cleaner station according to the embodiment of the present disclosure, FIG. 13 is a top plan view of FIG. 12, FIG. 17 is a perspective view illustrating a lower side of the discharge part, FIG. 18 is a cross-sectional view illustrating the robot cleaner station according to the embodiment of the present disclosure, and FIG. 19 is a rear enlarged view of the cross-sectional view of FIG. 15.

The discharge part of the robot cleaner station according to the embodiment of the present disclosure will be described below with reference to FIGS. 12 to 19.

The discharge part 180 may be positioned above the inner frame 150. Therefore, in case that wet vapor having a relatively high temperature is generated on the seating part 120, the wet vapor may flow to the upper side of the seating part 120 and be introduced into the discharge part.

The discharge part 180 may include the exhaust fan 181, the exhaust fan housing 182, the discharge part cover 183, and the discharge pipe 186.

The exhaust fan 181 may be positioned above the wet vapor inlet hole 151b of the inner frame 150. Therefore, when the exhaust fan 181 operates, wet vapor existing in the seating part 120 may be introduced into the wet vapor inlet hole 151b.

For example, the exhaust fan 181 may be a centrifugal fan, and a rotation axis of the exhaust fan 181 may be disposed in a direction intersecting the ground surface.

More specifically, the rotation axis of the exhaust fan 181 may be formed in a direction perpendicular to the ground surface, and the wet vapor introduced into the wet vapor inlet hole 151b may be discharged by the exhaust fan in a direction parallel to the ground surface. Therefore, the entire wet vapor existing at the upper side of the seating part 120 may be efficiently discharged, and an overall height of the robot cleaner station 100 may be reduced.

Meanwhile, the exhaust fan 181 may operate when the washing water is supplied or the heater 171d operates. That is, the exhaust fan 181 may operate in all operations in which wet vapor may be generated in the robot cleaner station 100.

More specifically, the exhaust fan 181 may operate in a washing water supply start step, a washing water supply progress step, and a washing water supply stop step and selectively operate in each of the steps. In addition, the exhaust fan 181 may operate in a driving start step, a driving step, and a driving stop step for the heater 171d and operate in each of the steps.

Therefore, because wet vapor may be introduced into the discharge part 180 at the same time when the wet vapor is generated, it is possible to prevent the occurrence of an offensive odor and proliferation of bacteria in the robot cleaner station 100.

The exhaust fan housing 182 may accommodate the exhaust fan 181 and be formed to cover an outer peripheral surface of the exhaust fan 181.

The exhaust fan housing 182 may be provided with the wet vapor outlet port 182a through which wet vapor introduced by the exhaust fan is discharged. The wet vapor outlet port 182a may be positioned rearward of the exhaust fan housing 182.

The exhaust fan housing 182 may have a cylindrical shape, as a whole. Because the wet vapor outlet port 182a is connected to a wall formed on the flow path forming portion 151a, a rear side of the exhaust fan housing 182 may be formed to correspond to a cross-section formed by the flow path forming portion 151a and the discharge part cover 183.

For example, a cross-section of a rear side of the exhaust fan housing 182 may be formed in a quadrangular shape. That is, a cross-section of the wet vapor outlet port 182a may be formed in a quadrangular shape.

Meanwhile, the discharge part 180 may further include a housing damper 187 provided to be in contact with an outer peripheral surface of the exhaust fan housing 182.

The housing damper 187 may be made of a material having elasticity. For example, the housing damper 187 may be made of rubber, silicone, polyurethane foam, or the like.

Therefore, the housing damper 187 may reduce vibration that may occur when the exhaust fan 181 operates, and the housing damper 187 may prevent the occurrence of a crack in the housing 110.

The discharge part cover 183 may be formed to cover an upper side of the exhaust fan housing 182 and an upper side of the flow path forming portion 151a. That is, the discharge part cover 183 positioned above the exhaust fan housing 182 may be formed to correspond to a shape of the exhaust fan housing 182, and the discharge part cover 183 positioned above the flow path forming portion 151a may be formed to correspond to a shape of the flow path forming portion 151a.

More specifically, when a front portion is defined as being positioned forward of the wet vapor outlet port 182a based on the wet vapor outlet port 182a and a rear portion is defined as being positioned rearward of the wet vapor outlet port 182a, the front portion of the discharge part cover 183 may be formed in a circular shape, and the rear portion of the discharge part cover 183 may be formed in a quadrangular shape.

In addition, the front portion of the discharge part cover 183 and the rear portion of the discharge part cover 183 may be connected and integrated.

Therefore, a space surrounded by the flow path forming portion 151a and the discharge part cover 183 may define a first flow path 184.

The first flow path 184 may be connected to the wet vapor outlet port 182a, and wet vapor discharged from the wet vapor outlet port 182a may flow rearward. In this case, a bottom surface of the flow path forming portion 151a may be formed to be inclined downward and rearward, such that wet vapor may flow toward a rear side of the first flow path even though the wet vapor is condensed into condensate water in the first flow path.

In addition, the first flow path 184 may be formed to be curved leftward or rightward. That is, a longitudinal axis of the first flow path 184 may be formed to intersect an imaginary line having a shortest distance from a front end to a rear end of the housing.

For example, when the first flow path 184 is formed to be curved in the direction in which the exhaust fan rotates, it is possible to improve efficiency in discharging wet vapor by preventing a turbulent flow caused when wet vapor discharged from the exhaust fan collides with the wall.

The discharge pipe 186 may be disposed between the first flow path 184 and the discharge pipe insertion groove 153da. The discharge pipe 186 may extend rearward from the discharge part cover 183 and be connected to a rear side of the flow path forming portion 151a.

In this case, the discharge pipe 186 may be formed with a shortest distance from the discharge part cover 183 and a rear end of the flow path forming portion 151a to the discharge pipe insertion groove 153da. For example, a discharge pipe 189 may be formed by extending a quadrangular tube in a straight shape. However, the present disclosure is not limited thereto.

Therefore, an internal space of the discharge pipe 186 may define a second flow path 186f, and the second flow path 186f may be formed as a straight flow path, such that wet vapor, which relatively decreases in flow velocity, may be quickly discharged, and the wet vapor may be efficiently discharged.

In addition, a vertical diameter of a discharge pipe 188 may be larger than a vertical diameter of the flow path forming portion 151a. Therefore, the wet vapor flowing from the flow path forming portion 151a to the discharge pipe 188 may come into contact with a larger amount of ambient air, which may increase a probability that the wet vapor may be condensed.

A lower surface of the discharge pipe 186 may include a first lower surface 186a, a connection surface 186b, and a second lower surface 186c.

The first lower surface 186a may be in contact with the flow path forming portion 151a, formed to extend rearward, and formed to be inclined downward and rearward. In addition, likewise, the second lower surface 186c may also be formed to be inclined downward and rearward.

The second lower surface 186c may be formed at a position lower than the first lower surface 186a. The first lower surface 186a and the second lower surface 186c may be connected to each other by the connection surface 186b.

A front end of the connection surface 186b may be connected to a rear end of the first lower surface 186a, and a rear end of the connection surface 186b may be connected to a front end of the second lower surface 186c. Therefore, the connection surface 186b may be formed to be inclined downward and rearward.

In this case, an angle at which the connection surface 186b is inclined downward may be larger than an angle at which the first lower surface 186a and the second lower surface 186c are inclined downward.

That is, a longitudinal axis of the connection surface 186b may intersect a longitudinal axis b1 of the first lower surface 186a and a longitudinal axis b3 of the second lower surface 186c. Therefore, a vertical diameter and a cross-sectional area of the discharge pipe 186 may increase as the discharge pipe 186 passes through the connection surface 186b.

With the above-mentioned structure, a velocity of the wet vapor flowing toward the rear side of the discharge pipe 186 decreases as the wet vapor passes through the connection surface 186b. When a pressure of the wet vapor increases as the velocity decreases, the amount of saturated water vapor may decrease, and the wet vapor may be condensed into condensate water. As a result, the condensate water may flow along a lower surface of the discharge pipe 186.

In addition, as the cross-sectional area of the discharge pipe 186 increases, the wet vapor may come into contact with a larger amount of ambient air, such that it is possible to increase a probability that wet vapor may be condensed into condensate water.

A discharge port 186d may be formed at a rear end of the discharge pipe 186, and the discharge port 186d may be inserted into the discharge pipe insertion groove 153da.

The discharge port 186d may discharge wet vapor or condensate water, which flows along the discharge pipe 188, to the upper rear cover 152.

The structure of the lower surface of the discharge pipe 188 may reduce a movement speed of wet vapor or condensate water flowing along the discharge pipe 188 and prevent wet vapor or condensate water discharged from the discharge port 186d from being sprayed and discharged.

Meanwhile, the discharge port 186d or a discharge part insertion groove 152da may be provided with a filter 186da that restricts introduction of foreign substances. When foreign substances, instead of wet vapor, is introduced into the discharge part 180 by driving power of the exhaust fan 181, the foreign substances may move to the drain hole 152ba. As a result, a drain hole 152da may be clogged. However, the filter 186da may be provided to prevent the drain hole 152da from being clogged.

### Control Configuration

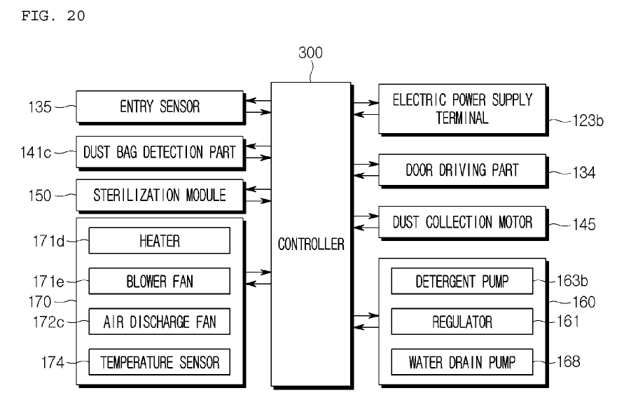

FIG. 20 is a block diagram for explaining a control configuration of the cleaner station according to the embodiment of the present disclosure.

The control configuration of the robot cleaner station 100 of the present disclosure will be described below with reference to FIG. 20.

The cleaner station 100 according to the embodiment of the present disclosure further include a controller 300 configured to control the seating part 120, the dust collection motor 145, the mop washing part 160, and the mop drying part 170.

The controller 300 may include a printed circuit board and elements mounted on the printed circuit board.

The controller 300 may receive a signal from the entry sensor 135 and control the door driving part 134.

The controller 300 may detect the approach of the robot cleaner 200 and control the door driving part 134 to rotate the door 131. Specifically, the controller 300 may detect, by means of the entry sensor 135, whether the robot cleaner 200 enters. Specifically, the controller 300 may open the inlet/outlet 127 by rotating the door 131 when a distance between the robot cleaner 200 and the door 131 is shorter than a preset distance. In addition, the controller 300 may close the inlet/outlet 127 by rotating the door 131 when the robot cleaner 200 is coupled to the seating part 120.

When electric power is supplied to the battery of the robot cleaner 200 from the electric power supply terminal 123b, the controller 300 may determine that the robot cleaner 200 is coupled to the seating part 120.

The controller 300 may operate the dust collection motor 145 to suck dust from the inside of the dust bin 220 of the robot cleaner 200.

Meanwhile, the robot cleaner station 100 according to the embodiment of the present disclosure may include a memory (not illustrated). The memory may include various data for operating or driving the robot cleaner station 100.

Meanwhile, the robot cleaner station 100 according to the embodiment of the present disclosure may include a communication part (not illustrated). The communication part may support wireless communication with other devices, such as the robot cleaner 200 or a terminal (not illustrated), existing outside the robot cleaner station 100. As a wireless communication module for wireless communication support, a near-field communication module or a far-field communication module may be provided.

For example, a short-range communication may be Bluetooth communication, near field communication (NFC) communication, or the like.

For example, the far-field communication may be wireless LAN (WLAN), digital living network alliance (DLNA), wireless broadband (Wibro), world interoperability for microwave access (Wimax), global system for mobile communication (GSM), code division multi-access (CDMA), code division multi-access 2000 (CDMA 2000), enhanced voice-data optimized or enhanced voice-data only (EV-DO), wideband CDMA (WCDMA), high-speed downlink packet access (HSDPA), high-speed uplink packet access (HSUPA), IEEE 802.16, long term evolution (LTE), long term evolution-advanced (LTEA), wireless mobile broadband service (WMBS), Bluetooth low energy (BLE), Zigbee, radio frequency (RF), long range LoRa, and the like.

The controller 300 may control the mop washing part 160.

Specifically, the controller 300 may control a detergent pump 163b. The controller 300 may operate the detergent pump 163b to discharge the detergent, which is stored in the detergent container 163, to the mop 242.

In addition, the controller 300 may control the regulator 162. The controller 300 may operate the regulator 162 to adjust the amount of purified water to be discharged to the mop 242.

In addition, the controller 300 may control a water drain pump 168. The controller 300 may operate the water drain pump 168 to drain wastewater produced after the mop 242 is washed.

The controller 300 may control the mop drying part 170.

Specifically, the controller 300 may control the heater 171d. The controller 300 may operate the heater 171dto heat air to be discharged to the mop 242.

In addition, the controller 300 may control the blower fan 171e. The controller 300 may operate the blower fan 171e to discharge air to the mop 242.

In addition, the controller 300 may control an air exhaust fan 172c. The controller 300 may operate the air exhaust fan 172c to discharge the air, which has been used to dry the mop 242, to the outside.

In addition, the controller 300 may receive a signal from a temperature sensor 174. The controller 300 may measure a temperature of air in the housing 110 based on temperature information received from the temperature sensor 174. Further, the controller 300 may sterilize bacteria present in the mop 242 by controlling the operation of the heater 171d based on temperature information received from the temperature sensor 174.

While the present disclosure has been described with reference to the specific embodiments, the specific embodiments are only for specifically explaining the present disclosure, and the present disclosure is not limited to the specific embodiments. It is apparent that the present disclosure may be modified or altered by those skilled in the art without departing from the technical spirit of the present disclosure.

All the simple modifications or alterations to the present disclosure fall within the scope of the present disclosure, and the specific protection scope of the present disclosure will be defined by the appended claims.

### DESCRIPTION OF REFERENCE NUMERALS

100: Robot cleaner station

110: Housing

113: Upper cover

120: Seating part

121: Base

123: Coupling wall

124: Inner wall

128: Washing tub

130: Door part

140: Dust collection part

145: Dust collection motor

150: Inner frame

151: Upper surface

151a: Flow path forming portion

151aa: Flow path forming portion sidewall

151b: Wet vapor inlet hole

151c: Exhaust fan mounting groove

152: Upper rear cover

152a: Bent portion

152b: Cover bottom surface

152ba: Drain hole

152c: Rear rib

152da: Discharge part insertion groove

160: Mop washing part

170: Mop drying part

171d: Heater

171e: Blower fan

180: Discharge part

181: Exhaust fan

182: Exhaust fan housing

182a: Wet vapor outlet port

183: Discharge part cover

183a: Cover wall

184: First flow path

186: Discharge pipe

186a: First lower surface

186b: Connection surface

186c: Second lower surface

186d: Discharge port

186da: Filter

186f: Second flow path

187: Housing damper

200: Robot cleaner

300: Controller

What is claimed is:

1. A robot cleaner station comprising:
a housing;
a discharge part configured to discharge wet vapor existing in the housing;
a base disposed in the housing and configured such that at least a part of a robot cleaner is seated on the base; and
an inner frame positioned above the base,
wherein the discharge part comprises a exhaust fan disposed above the inner frame and configured to allow the wet vapor to flow,
wherein the inner frame is formed with a wet vapor inlet hole so that the wet vapor is introduced, and
wherein the wet vapor inlet hole is positioned below the exhaust fan.

2. The robot cleaner station of claim 1, wherein the inner frame comprises a flow path forming portion positioned rearward of the wet vapor inlet hole and configured to guide the wet vapor discharged from the exhaust fan,
wherein the discharge part comprises:
a discharge part cover positioned above the exhaust fan and configured to cover the exhaust fan and an upper side of the flow path forming portion; and
a discharge pipe extending rearward from the discharge part cover and connected to a rear side of the flow path forming portion, and
wherein a vertical diameter of the discharge pipe is larger than a vertical diameter of the flow path forming portion.

3. The robot cleaner station of claim 2, wherein a lower surface of the discharge pipe comprises a connection portion having a point at which an angle at which the connection portion is inclined downward is changed.

4. The robot cleaner station of claim 2, wherein a lower surface of the discharge pipe comprises:
a first lower surface extending from a rear end of the flow path forming portion; and
a second lower surface positioned rearward of the first lower surface, and
wherein a vertical diameter from the first lower surface to a discharge part cover is smaller than a vertical diameter from the second lower surface to the discharge part cover.

5. The robot cleaner station of claim 2, wherein a bottom surface of the flow path forming portion is formed to be inclined downward and rearward.

6. The robot cleaner station of claim 2, wherein the discharge part comprises:
a wet vapor outlet port positioned rearward of the exhaust fan and configured to allow the wet vapor to be discharged; and
a first flow path formed between the discharge part cover and the flow path forming portion and configured to allow the wet vapor discharged from the wet vapor outlet port to flow, and
wherein a longitudinal axis of the first flow path intersects an imaginary line having a shortest distance from a front end to a rear end of the housing.

7. The robot cleaner station of claim 1, further comprising:
an upper rear cover positioned rearward of the discharge part and configured to cover an upper side of a station internal configuration,
wherein the upper rear cover comprises a partition wall connected to left and right outer walls of the housing and provided with a discharge part insertion groove into which a rear end of the discharge part is inserted.

8. The robot cleaner station of claim 7, wherein the upper rear cover comprises:
a bent portion positioned below the partition wall and formed by being bent downward from the rear end of the discharge part;
a cover bottom surface extending rearward from a lower end of the bent portion and formed to be inclined upward and rearward; and
a rear rib protruding upward from a rear end of the bottom surface.

9. The robot cleaner station of claim 7, wherein the housing comprises an upper cover positioned above the inner frame, and
wherein a rear end of the upper cover is bent downward and coupled to a rear end of the upper rear cover.

10. The robot cleaner station of claim 7, wherein the upper rear cover comprises a drain hole through which condensate water is discharged.

11. The robot cleaner station of claim 10, wherein a bottom surface of the upper rear cover is formed to be inclined downward in a direction in which the drain hole is positioned.

12. The robot cleaner station of claim 1, wherein the discharge part is disposed in a direction in which a rotation axis of the exhaust fan intersects a ground surface.

13. The robot cleaner station of claim 7, wherein the discharge part insertion groove is provided with a filter configured to restrict introduction of foreign substances.

14. The robot cleaner station of claim 1, wherein the discharge part further comprises:
a exhaust fan housing configured to accommodate the exhaust fan; and
a housing damper provided to be in contact with a part of an outer peripheral surface of the exhaust fan housing.

15. The robot cleaner station of claim 1, further comprising:
a mop washing part positioned at a left or right side of the base and configured to supply washing water and wash a mop,
wherein the exhaust fan operates when the washing water is supplied.

16. The robot cleaner station of claim 1, further comprising:
a mop drying part positioned rearward of the base, provided with a heater, and configured to dry a mop,
wherein the exhaust fan operates when the heater operates.
